(19) United States
(12) Patent Application Publication
(10) Pub. No.: US 2021/0009310 A1
(43) Pub. Date: Jan. 14, 2021

(54) PALLET MANAGEMENT DEVICE

(71) Applicant: MyOmega Systems GmbH, Nuremberg (DE)

(72) Inventors: Bernd Moeller, Henfenfeld (DE); Christian Winkelmeyr, Kirchheim (DE); Gkergki Nakas, Nuremberg (DE)

(73) Assignee: MyOmega Systems GmbH, Nuremberg (DE)

(21) Appl. No.: 16/636,688

(22) PCT Filed: Jul. 31, 2019
(86) PCT No.: PCT/IB2019/000878

§ 371 Date: Feb. 5, 2020

Related U.S. Application Data
(60) Provisional application No. 62/714,818, filed on Aug. 6, 2018.

(51) Int. Cl. B65D 19/38; G06K 19/07; G06K 19/077; G06F 8/65; H04L 9/06; G01G 19/52

(52) U.S. Cl. CPC B65D 19/38; G06K 19/0723; G06K 19/07786; H04L 2209/38; H04L 9/0643; G01G 19/52; B65D 2203/10; G06F 8/65

(57) ABSTRACT

A device for monitoring and managing a pallet includes one or more sensors for determining properties associated with a pallet, which may include a weight of a load of a pallet, and the presence, number and/or location of one or more load items on a pallet. The device may be physically coupled to a pallet, and may include a processing unit coupled to the one or more sensors, the processing unit having one or more interfaces to communicate with the one or more sensors, and one or more interfaces to communicate with one or more networks. The device may include one or more hydraulic mats including one or more pressure sensors, and RFID (UHF) and/or optical code readers for detecting and/or identifying load items. The device may include RFID (NFC) readers for exchange of payment and access information. The device also may include multiple layers, each of which may include one or more cavities for accommodating components of the device.

### CROSS-REFERENCE TO RELATED APPLICATION

This application claims priority to U.S. provisional patent application No. 62/714,818 filed on Aug. 6, 2018 titled “Pallet System,” which is incorporated by reference herein.

### TECHNICAL FIELD

This application is directed to the field of remote monitoring and management of things, and more particularly to remote monitoring and management of pallets.

### BACKGROUND OF THE INVENTION

Pallets are widely used in industry today. Pallets can be used to carry/support any of a variety of loads, for example, during storage, transport or sale (e.g., in a store or other market) of goods. For example, pallets may be used to carry: kegs, including standardized barrels to transport for example food & beverages; drums, including standardized barrels to transport for example oil chemicals; bags, in different shapes to transport any kind of solid bulk materials; containers or carriers of different types, including Kleinteile Ladungs Träger (KLT) containers (hereinafter “KLTs”), for example, for C-parts (e.g., small parts like screws, nuts and washers) made available by Würth Industrie Service GmbH & Co. KG or Schaefer Systems International Inc (SSI Schafer); and other items.

In some places, for example, Europe, pallets are standardized. Ecosystems have evolved for pallets in various markets, including Europe and elsewhere, which may include one or more of the following services and offerings in various markets: standardized production with guaranteed quality; a return system for returning the pallet at any place, without any extra shipment; pallet repairs, including defined service points; and standardized sizes and types.

One of the more successful worldwide ecosystems is the EPAL system promulgated by the European Pallet Association. The EPAL system has developed specifications that standardize various aspect of pallets, the standardized pallets referred herein as Euro pallets or EPAL pallets (and also known as EUR pallets). Different standard Euro pallets, i.e., Euro pallets having different standardized properties, have been defined. For example, FIGS. 1a-1c illustrate multiple views of an EPAL 1 pallet 150. Standard properties defined for an EPAL 1 pallet include, but are not limited to: 3 bottom boards 152a-152c of specific dimensions; 5 top boards 156a-e of specific dimensions; 9 blocks (including 154a-e) of specific dimensions connecting the bottom boards to the tope boards; a length 158=1200 m (with some tolerance); a width 160=1600 mm (with some tolerance); and a height 162=144 m (with some tolerance); and 78 nails to fasten parts of the pallet together, including 5 per block at specified locations.

It may be desirable to monitor and manage the lifecycle of a pallet, for example, from production of the pallet, through loading, transport, unloading and repair, until an end-of-life of the pallet. To do so, one could introduce electronics or other elements into or onto the pallet, including, for example, sensors for detecting physical properties, location and other properties, communication and networking components for exchanging information across networks; and batteries or other power sources for powering the other elements. For example, one could add elements to one or more blocks of the pallet (e.g., a GPS or other networking element, battery, RFID component, sensors), but doing so may change one or more properties of the pallet, especially if this requires removing one or more nails from the block or deviating the location of the nails from what is specified by an EPAL standard. Pallets, in particular, Euro pallets, are a mass market article, consumed in millions of units, and made available at almost any logistics service provider. Accordingly, any modifications of a pallet design from a standard Euro pallet, regardless of how small, may have significant impact on a pallet ecosystem.

Other possible modifications involving the introduction of electronics, sensors or other elements may include hollowing out an interior of a block or replacing one or more wooden blocks with a plastic or polymer block into which electronic components could be inserted, or perhaps making similar modifications to boards of the pallet. However, all such approaches may change properties of the pallet, perhaps in unforeseen ways, and render the pallet non-compliant with standards, including EPAL standards, and/or disrupt the pallet ecosystem.

What is desired is the ability to be able to monitor and manage, including remotely, the lifecycle of a pallet without having to modify the pallet itself, and being able to do so in a reliable manner.

### SUMMARY OF THE INVENTION

According to the system described herein, a device for monitoring a pallet includes one or more layers including one or more elements for attaching the device to the pallet, one or more sensors physically coupled to the one or more layers, the one or more sensors detecting one or more properties associated with the pallet, each of the one or more sensors producing a signal indicative of one or more properties associated with the pallet, and a processing unit physically coupled to the one or more layers and communicatively coupled to the one or more sensors, the processing unit receiving and processing signals produced by the one or more sensors. The one or more properties may include one or more properties of the pallet. The one or more properties may include one or more properties of a load carried by the pallet. The one or more sensors may include at least a first sensor for detecting a weight of a load carried by the pallet. A load carried by pallet may include a one or more items and the one or more sensors may include at least a first sensor for detecting a location of at least a first of the one or more items relative to the pallet. The one or more sensors may include at least a first sensor for detecting an identifier of the pallet and/or an identifier of one or more items carried by the palette. The one or more sensors may include one or more hydraulic mats. The one or more sensors may include one or more RFID (UHF) readers and/or one or more RFID (NFC) readers. The one or more sensors may include at least one sensor positioned at a location within the assembly based at least in part on one or more types of anticipated loads of the pallet. The at least one sensor may include a plurality of sensors arranged in a pattern based at least in part on the one or more types of anticipated loads of the pallet. At least one of the sensors may be arranged at a location within the assembly based at least in part on an anticipated location of a block within the pallet. A plurality of the sensors may be arranged in a pattern based at least in part on standardized requirements of a Euro pallet. The device may have one or more physical dimensions based at least in part on standardized requirements of a Euro pallet. The device may have one or more layers including a cavity for accommodating at least one of the one or more sensors. The device may have one or more layers including a cavity for accommodating one or more electrical components. The device may have one or more layers for accommodating straps that secure items carried by the pallet to the assembly. The device may have one or more layers for accommodating straps that secure the assembly to the pallet. The device may include a plurality of layers, at least a first layer of the plurality of layers having a first surface for contacting the pallet and a second surface for contacting at least a second layer of the plurality of layers, the at least second layer accommodating the one or more sensors. The processing unit may include one or more network interfaces to communicate status information associated with the pallet to a pallet management network. The one or more network interfaces may communicate status information associated with the pallet as transaction blocks of a blockchain. The one or more network interfaces may receive a remotely transmitted digitally signed software update, the device logic authenticates the software update and, if the software is authentic, update software on the at least one device with the authenticated software. The processing unit may include a trusted platform module to secure information stored on and/or communicated from the device. The processing unit may determine one or more actions to be taken for the pallet based at least in part on the one or more detected properties.

According further to the system described herein, monitoring a pallet using a device physically coupled thereto includes detecting one or more properties associated with the pallet using one or more sensors included in the device to produce a signal indicative of the one or more properties and processing the signals produced by the one or more sensors using a processor included in the device. Detecting one or more properties may include detecting a fluid pressure acting on the device. Monitoring a pallet using a device physically coupled thereto may also include determining a weight of a load carried by the pallet from the detected fluid pressure. Detecting one more properties may include detecting the presence of one or more items carried by the pallet. Monitoring a pallet using a device physically coupled thereto may also include transmitting one or more communication to a network, the one or more communications including information based on the one or more detected properties. The one or more sensors may include one or more hydraulic mats. The one or more sensors may include one or more RFID (UHF) readers and/or one or more RFID (NFC) readers. The one or more sensors may include at least one sensor positioned at a location within the assembly based at least in part on one or more types of anticipated loads of the pallet. The at least one sensor may include a plurality of sensors arranged in a pattern based at least in part on the one or more types of anticipated loads of the pallet. At least one of the sensors may be arranged at a location within the assembly based at least in part on an anticipated location of a block within the pallet. A plurality of the sensors may be arranged in a pattern based at least in part on standardized requirements of a Euro pallet. The processor may be coupled to one or more network interfaces to communicate status information associated with the pallet to a pallet management network. The one or more network interfaces may communicate status information associated with the pallet as transaction blocks of a blockchain. The one or more network interfaces may receive a remotely transmitted digitally signed software update, the device logic may authenticate the software update and, if the software is authentic, may update software on the at least one device with the authenticated software. The processor may be coupled to a trusted platform module to secure information stored on and/or communicated from the device. The processor may determine one or more actions to be taken for the pallet based at least in part on the one or more detected properties.

According further to the system described herein, making a device for monitoring a pallet includes providing a first layer of the device having a first surface to contact loads carried by a pallet, placing one or more sensors for detecting one or more properties associated with the pallet on the first layer to produce a signal indicative of one or more properties associated with the pallet, placing a processing unit in the first layer, the processing unit to receive and process signals produced by the one or more sensors, and placing at least a second layer over the first layer, the at least second layer having a second surface for contacting a pallet. The first layer may have one or more cavities, where placing the one or more sensors includes placing at least one of the one or more sensors in one of the one or more cavities, and where placing the processing unit includes placing the processing unit within one of the one or more cavities. Placing one or more sensors may include placing one or more hydraulic mats on the first layer. Placing one or more sensors may include placing one or more RFID (UHF) readers and/or RFID (NFC) readers. Making a device for monitoring a pallet may also include downloading IPU software to the IPU, where the IPU software includes device under test functionality, personalizing the IPU with public and private keys, locking the TPM after personalizing the IPU, determining whether the one or more sensors and the processing unit are working satisfactorily, if the one or more sensors or the processing unit are not working satisfactorily, performing corrective action, and repeating the determining and the performing of corrective action if necessary until it is determined that the one or more sensors and processing unit are working properly, where the at least second layer is placed over the first layer only after it is determined that the one or more sensors and processing unit are working properly.

According further to the system described herein, a system for managing a lifecycle of each of a plurality of pallets remotely located from one or more servers has at least a first database defining information for managing the lifecycles of the plurality pallets, each of the plurality of pallets having a pallet monitoring device physically coupled thereto. The pallet monitoring device includes one or more sensors to detect one or more properties associated with the pallet. The system includes one or more pallet management components communicatively coupled to, and remotely located from, the one or more servers, where each pallet management component manages, at least in part, a lifecycle of one or more of the plurality of pallets based at least in part on the information defined in the first database. At least one of the one or more pallet management components may be included in a gateway communicatively coupled to, and remotely located from, at least one pallet monitoring device physically coupled to the one or more pallets, where the gateway manages, at least in part, the lifecycle of the one or more pallets by exchanging communications with the at least one pallet monitoring device. At least one of the one or more pallet management components may be included in a pallet monitoring device physically coupled to the one or more pallets, where the pallet monitoring device is in direct communication with at least one of the one or more servers. The defined information may include a plurality of defined states within a pallet lifecycle for the plurality of pallets. Each of the plurality of pallets may have a current defined state from among the plurality of defined states, where at least a first of the one or more pallet management components determines one or more actions to be taken for at least a first of the plurality of pallets based on the current defined state of the first pallet and one or more detected properties associated with the first pallet. The one or more detected properties may include at least a weight of a load being carried by the at least first pallet. The one or more pallet management components may communicate information about one or more of the plurality of pallets to the one or more servers as transaction blocks of a blockchain. One or more transactions corresponding to one or more of the plurality of pallets may be stored as a smart contract in blockchain form. At least one pallet monitoring device physically coupled to a pallet may receive a remotely transmitted digitally signed software update, may authenticate the software update and, if the software is authentic, may update software on the at least one pallet monitoring device with the authenticated software. The system may also include one or more applications that maintain an inventory of the plurality of pallets based at least in part on information transmitted by the pallet monitoring devices physically coupled to the pallets. The system may also include one or more applications that automatically order more pallets for an entity based at least in part on information transmitted by the pallet monitoring devices physically coupled to the pallets. The system may also include one or more gateways that communicates with the one or more pallet management components, where each of the pallet management components creates an inventory of goods stored at a corresponding one of the pallets and where each of the pallets and the goods are stored within a physical location corresponding to the one or more gateways and where an inventory application creates a database representing and maintaining the goods stored within the physical location to form a digital twin of a warehouse database for each of the pallets. The system may also include data stored in an inventory application of a transformation layer within the pallet monitoring device, where the data represents a load stored at the pallet, a load specification of a load stored at the pallet, and/or load safety instructions of a load stored at the pallet and where a user device may access the data via communication interfaces of the pallet management device. The communication interfaces may be accessed through a network or through a direct communication channel. The communication interfaces may be accessed through via an RFID NFC reader.

According further to the system described herein, a lifecycle of each of a plurality of pallets is remotely located from one or more servers having at least a first database defining information for managing the lifecycles of the plurality pallets. Each of the plurality of pallets has a pallet monitoring device physically coupled thereto. The pallet monitoring device includes one or more sensors to detect one or more properties associated with the pallet. The lifecycle is managed by using pallet management components communicatively coupled to, and remotely located from, the one or more servers, to manage, at least in part, a lifecycle of one or more of the plurality of pallets based at least in part on the information defined in the first database. At least one of the one or more pallet management components may be included in a gateway communicatively coupled to, and remotely located from, at least one pallet monitoring device physically coupled to the one or more pallets, where the gateway manages, at least in part, the lifecycle of the one or more pallets by exchanging communications with the at least one pallet monitoring device. At least one of the one or more pallet management components may be included in a pallet monitoring device physically coupled to the one or more pallets, where the pallet monitoring device is in direct communication with at least one of the one or more servers. The defined information may include a plurality of defined states within a pallet lifecycle for the plurality of pallets. Each of the plurality of pallets may have a current defined state from among the plurality of defined states and the lifecycle is managed by determining one or more actions to be taken for at least a first of the plurality of pallets based on the current defined state of the first pallet and one or more detected properties associated with the first pallet. The one or more detected properties may include at least a weight of a load being carried by the at least first pallet. The lifecycle may be managed by communicating information about one or more of the plurality of pallets to the one or more servers as transaction blocks of a blockchain. The lifecycle may be managed by storing one or more transactions corresponding to one or more of the plurality of pallets as a smart contract in blockchain form. The lifecycle may be managed by receiving a remotely transmitted digitally signed software update, authenticating the software update, and, if the software is authentic, updating software on the at least one pallet monitoring device with the authenticated software. The lifecycle may be managed by maintaining an inventory of the plurality of pallets based at least in part on information transmitted by the pallet monitoring devices physically coupled to the pallets. The lifecycle may be managed by automatically ordering more pallets for an entity based at least in part on information transmitted by the pallet monitoring devices physically coupled to the pallets.

According further to the system described herein, one or more non-transitory computer-readable media has software stored thereon for managing a lifecycle of each of a plurality of pallets remotely located from one or more servers having at least a first database defining information for managing the lifecycles of the plurality pallets. Each of the plurality of pallets has a pallet monitoring device physically coupled thereto, the pallet monitoring device including one or more sensors to detect one or more properties associated with the pallet. The software includes executable code that uses pallet management components communicatively coupled to, and remotely located from, the one or more servers, to manage, at least in part, a lifecycle of one or more of the plurality of pallets based at least in part on the information defined in the first database. The software may be included in a gateway communicatively coupled to, and remotely located from, at least one pallet monitoring device physically coupled to the one or more pallets, where the gateway manages, at least in part, the lifecycle of the one or more pallets by exchanging communications with the at least one pallet monitoring device. The software may be included in a pallet monitoring device physically coupled to the one or more pallets, where the pallet monitoring device is in direct communication with at least one of the one or more servers. The defined information may include a plurality of defined states within a pallet lifecycle for the plurality of pallets. Each of the plurality of pallets may have a current defined state from among the plurality of defined states and the software may further include executable code that determines one or more actions to be taken for at least a first of the plurality of pallets based on the current defined state of the first pallet and one or more detected properties associated with the first pallet. The one or more detected properties may include at least a weight of a load being carried by the at least first pallet. The software may further include executable code that communicates information about one or more of the plurality of pallets to the one or more servers as transaction blocks of a blockchain. The software may further include executable code that stores one or more transactions corresponding to one or more of the plurality of pallets as a smart contract in blockchain form. The software may further include executable code that receives a remotely transmitted digitally signed software update, executable code that authenticates the software update, and executable code that, if the software is authentic, updates software on the at least one pallet monitoring device with the authenticated software. The software may further include executable code that maintains an inventory of the plurality of pallets based at least in part on information transmitted by the pallet monitoring devices physically coupled to the pallets. The software may further include executable code that automatically orders more pallets for an entity based at least in part on information transmitted by the pallet monitoring devices physically coupled to the pallets.

### BRIEF DESCRIPTION OF THE DRAWINGS

FIG. 1A is a perspective view of a conventional Euro pallet;

FIG. 1B is a top view of a conventional Euro pallet;

FIG. 1C is a side view of a conventional Euro pallet;

FIG. 2 is a block diagram illustrating an example of a pallet monitoring device (PMD) coupled to a pallet according to embodiments of the system described herein;

FIG. 3A is an image illustrating an example of kegs loaded on a pallet, according to embodiments of the system described herein;

FIG. 3B is an image illustrating an example of drums loaded on a pallet, according to embodiments of the system described herein;

FIGS. 3C and 3D are each an image illustrating an example of bags loaded on a pallet, according to embodiments of the system described herein;

FIG. 3E is an image illustrating an example of containers loaded on a pallet, according to embodiments of the system described herein;

FIGS. 4A and 4B are each a schematic illustrating an example of a grid for determining an arrangement of one or more components of a pallet monitoring device, according to embodiments of the system described herein;

FIGS. 5A and 5B are each a block diagram illustrating an example of a pallet monitoring device, according to embodiments of the system described herein;

FIG. 6A is a block diagram illustrating an example of side view of a pallet monitoring device having multiple layers, according to embodiments of the system described herein;

FIG. 6B is a diagram illustrating an example of a perspective view of a pallet monitoring device having multiple layers, according to embodiments of the system described herein;

FIG. 7 is a flowchart illustrating an example of a method of producing a pallet monitoring device, according to embodiments of the system described herein;

FIG. 8 is a diagram illustrates an example of a hydraulic mat including a pressure sensor, according to embodiments of the system described herein;

FIG. 9A is a block diagram illustrating an example of a system for remotely monitoring and managing pallets, according to embodiments of the system described herein;

FIG. 9B is a block diagram illustrating an example of using secure transaction records to communicate and store pallet-related information on a pallet management network according to embodiments of the system described herein;

FIG. 10 is a state diagram illustrating an example of a plurality of defined states of a pallet lifecycle, according to embodiments of the system described herein;

FIGS. 11A and 11B collectively are a flowchart illustrating an example of managing a lifecycle of a pallet, according to embodiments of the system described herein;

FIGS. 12A and 12B collectively are a flowchart illustrating an example implementing a deep sleep mode for a pallet monitoring device, according to embodiments of the system described herein;

FIG. 13 is a flowchart illustrating an example of transitioning a pallet monitoring device to an idle state, according to embodiments of the system described herein;

FIGS. 14A and 14B collectively are a flowchart illustrating an example of method of managing loading a pallet, according to embodiments of the system described herein; and

FIG. 15 illustrates a table specifying threshold values for physical properties associated with a hydraulic mat, according to embodiments of the system described herein.

### DETAILED DESCRIPTION OF VARIOUS EMBODIMENTS

Described herein is a system, including devices and techniques, for remotely monitoring and managing the lifecycle of pallets. A pallet monitoring device (PMD) may be physically coupled to a pallet and include multiple types of sensors and/or sensor interfaces for detecting properties associated with a pallet, including properties of the pallet, a load borne by the pallet and/or the pallet monitoring device itself, including but not limited to: presence of a load, weight of a load, number of items in a load, temperature, humidity, pressure, structural condition of a pallet, and location. Such sensors may include, for example: one or more sensors for detecting the weight of a load borne by the pallet (e.g., one or more of such sensors may be included in one or more hydraulic mats), RFID readers, optical code readers, and one or more other types of sensors. The pallet monitoring device also may include and/or interfaces to any of the foregoing types of sensors. The pallet monitoring device may be configured with intelligence to analyze the information received from multiple sensors, determine actions to be taken, and control such actions. In this sense, the pallet monitoring device may be considered a smart or intelligent monitoring device.

The intelligence of the pallet monitoring device may be embodied in one more components of the pallet monitoring device, including but not limited to an intelligent processing unit (IPU), which may be implemented on a printed circuit board (PCB). The pallet monitoring device may be configured to be readily attached (e.g., mounted) and detached from a pallet, and may be designed to be physically robust for outdoor use, or even being compliant to hazardous areas (e.g., ATEX, NEC 500/NEC 5059 compliance).

The pallet monitoring device may include one or more elements for physically coupling the pallet monitoring device to a pallet. The pallet monitoring device may be constructed to include multiple layers, including a layer designed to have a first surface in contact with a pallet and another layer having a surface designed to be in contact with a load of a pallet, and the pallet monitoring device may be configured to physically accommodate one or more sensors, electronic components and/or other components. For example, one or more of the layers may be configured with one or more cavities to accommodate one or more sensors, electronic components or other components (or multiple layers may be configured such that they together form one or more cavities). The pallet monitoring device, and the individual components thereof, may be designed to withstand, over time, the forces imposed by any loads for which the pallet is configured to bear.

In some embodiments of the system described herein, the pallet monitoring device may be comprised of one or more integrated or interconnected discrete components, each of which may be, or include, mechanical, electrical, optical and/or magnetic components, or any suitable combination of the foregoing, in which case the pallet monitoring device may be considered as an arrangement or assembly of such components.

In some embodiments of the system described herein, a pallet monitoring device (PMD) may include one or more hydraulic mats including one or more pressure sensors for detecting the fluid pressure imposed on the hydraulic mats by a load. The detected pressure measurements may be used to determine a weight of a pallet load. PMDs also may include one or more RFID/QRC sensors for determining the presence, number and/or location of one or more load items (e.g., kegs, drums, KLTs, bags or other containers or packages) carried by a pallet.

A pallet monitoring device may detect, determine, record and/or communicate a variety of information associated with a pallet, including information about the pallet, a load of the pallet and the pallet monitoring device itself. This information may include any of: an identifier (e.g., product number) of the pallet, for example, identified via a QRC/RFID label; identifiers of items carried by the pallet, for example, as identified via QRC/RFID labels; an identity of the pallet monitoring device itself; addresses of a customer of a pallet; information concerning interactions between the pallet monitoring device and a pallet management network or other network; product specifications of any of the foregoing such as, for example, bills of loading, certificates of analysis and safety data sheets. Such information may be stored within a non-volatile memory of the pallet monitoring device; via references to documents stored inside the cloud (e.g., in a pallet management network); and/or on the pallet management network itself.

A pallet monitoring device as described herein may be part of a pallet management network, which may be considered a kind of internet-of-things (IoT) system. The pallet management network may include one or more gateway devices communicatively coupled to the pallet monitoring devices and to one or more servers of a cloud layer of the pallet management network. The pallet monitoring device may include one or more network interfaces for communicating with the pallet management network, for example, via gateways, and may be configured with technologies for communicating with a plurality of types of networks, including, for example, cellular/mobile (5G, LTE (4G), 3G (WCDMA), CDMA, GSM, etc.), Wi-Fi, GPS, ISM/EU (sub-1-Ghz), and Ultra-Wideband (UWB) technology, and/or any other appropriate network technology. The pallet monitoring device may be configured to use the networking technology to determine a location and a change of location of a pallet, and also to communicate status information of the pallet to the pallet management network and receive information from the pallet management network. The status information may include one or more properties detected or determined by the pallet monitoring device and other information, and the information received by the pallet monitoring device may include instructions, updated pallet information based on analysis performed by a gateway, server or other network components, technology updates and other information. The servers, gateways and pallet monitoring devices may be configured to communicate information with each other in an efficient manner, according to predefined schedules, and may use blockchain technology to communicate and store such information in transaction blocks. Blockchain technology also may be used to communicate and store transactions between parties (e.g., pallet producers, OEMs, customers, transporters) concerning pallets, for example, as smart contracts.

In some embodiments, a pallet monitoring device may be configured to communicate directly to one or more servers of the cloud layer without using a gateway as an intermediary. In such embodiments, the pallet monitoring device may be configured with any of the capabilities described herein in relation to gateways and may include any of the components of a gateway described herein.

The cloud layer of the pallet management network may include, as embodied on one or more servers, services and applications for remotely monitoring and managing pallets, and these services and applications, or portions thereof, may be implemented on gateways and pallet monitoring devices as well. Information concerning pallets, pallet loads and lifecycle management of the pallets may be stored in the cloud layer on one or more servers and used by the services and applications. Lifecycle management information may include one or more defined states corresponding to phases in the lifecycle of a pallet, and may include any of: an idle state; a pallet production state; a preparation state; a pallet loading state; a transport-to-customer state; a monitor-at-customer state; a transport-back-to-OEM state; an EOL state; a transport-to-production state; other states; or any suitable combination of the foregoing, each of which is described in more detail below.

The phases of a pallet lifecycle represented by the defined states described herein may be considered to correspond to aspects of a Kanban manufacturing management system. Thus, embodiments of the system described herein may be used to implement what may be considered a smart Kanban process.

In the idle state, defined in more detail below, components of the pallet monitoring device may be powered down to conserve power. In a deep sleep mode of operation, the pallet monitoring device may be awakened from time-to-time, e.g., periodically, at predefined times of day, at predefined days of week, month or year, in response to instruction, and/or in response to detected movement of the pallet monitoring device (and by inference the pallet). While awake, i.e., in an active state, the pallet monitoring device may power-on components, detect properties, analyze the properties and other information, store status information, transmit the status information to a gateway if possible, and then return to the idle state. These steps may be repeated until it is decided to exit the deep sleep mode, for example, in response to a change of defined state. The time during which the pallet monitoring device is awake during deep sleep mode may be configured to be short compared to the time during which it is idle during deep sleep mode, to thereby maximize power conservation, and possibly extend the life of the pallet monitoring device components.

Gateways and pallet monitoring devices of the pallet management network may be configured with knowledge of these defined states of a pallet lifecycle. The current defined state and changes to the defined state may be included in the information communicated between pallet monitoring devices, gateways and servers, and used in analysis performed and decisions made by any of these components. That is, the intelligence with which the pallet monitoring device is configured to determine actions to be taken and to control such actions may include considering the current defined state of a pallet along with information received from sensors. For given information detected from one or more sensors, the action determined may differ for different defined states. The pallet monitoring device also may include a movement sensor to detect movement of the pallet monitoring device, for example, acceleration of the pallet monitoring device, in multiple dimensions, and may include a timer component. The movement sensor and timer component may be configured to wake-up the pallet monitoring device in response to movement or a particular time or elapsed time, respectively, as described below in more detail.

The system described herein, which will now be described in more detail in relation to the drawings, provides a holistic solution for remotely managing the lifecycle of pallets in a more flexible, reliable, efficient and comprehensive manner than previously existed. It should be appreciated that, while various embodiments of the system described herein are described primarily in relation to Euro pallets, the invention is not so limited, and may apply to use with other types of pallets.

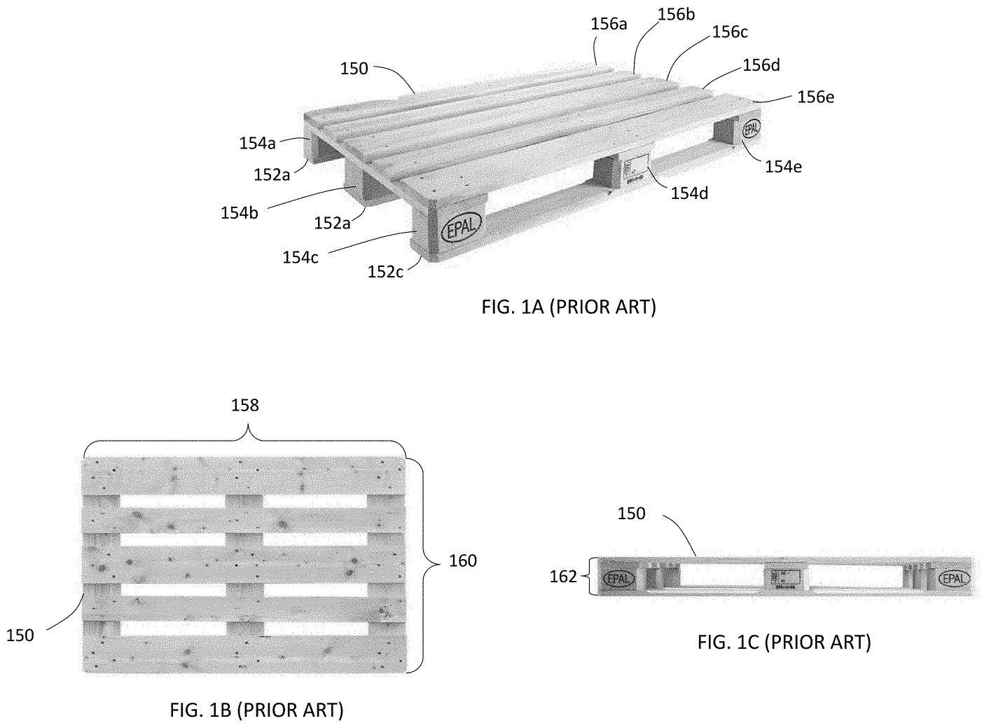

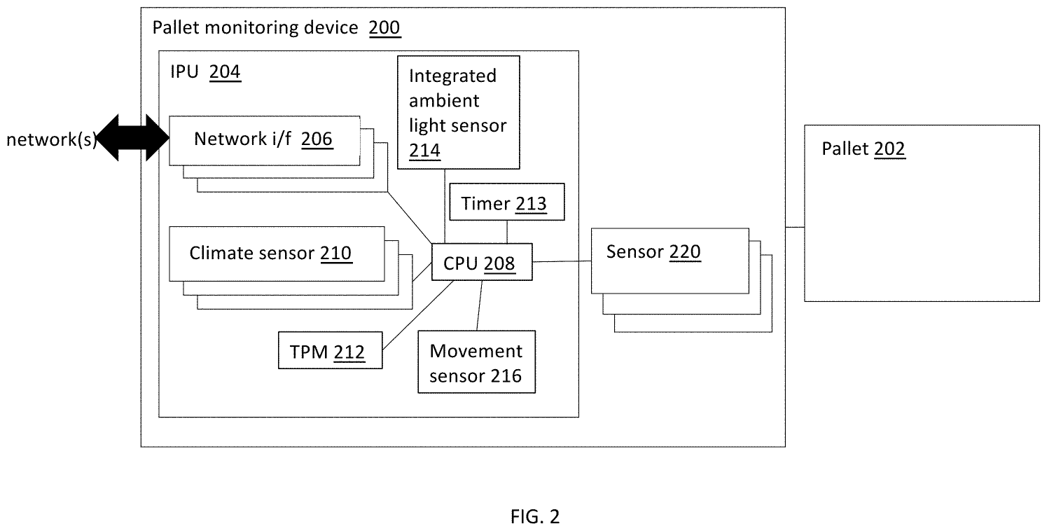

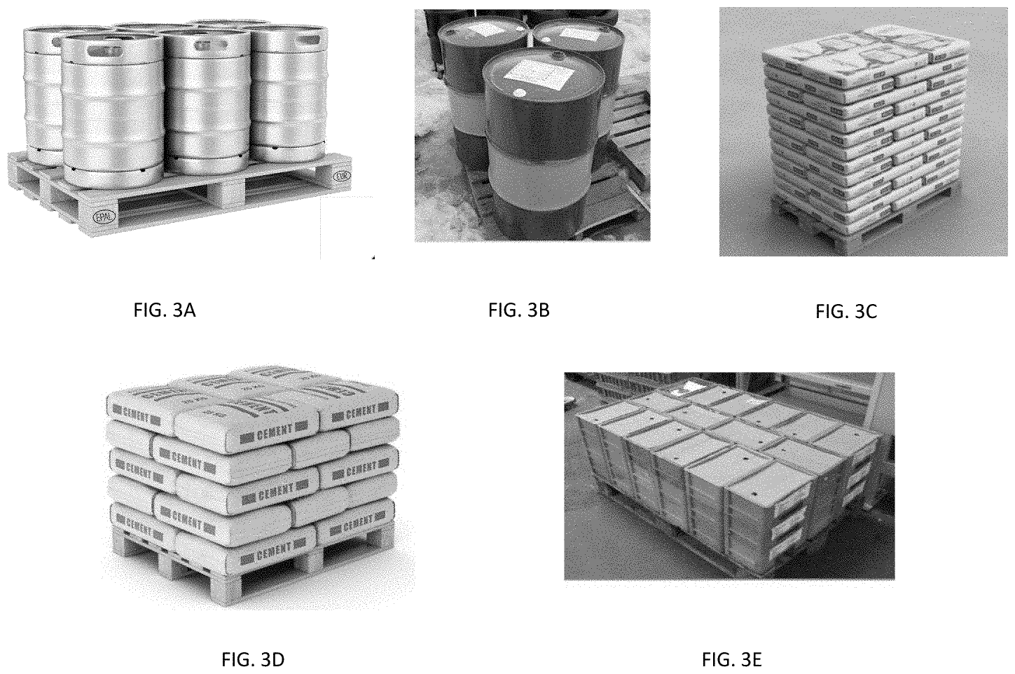

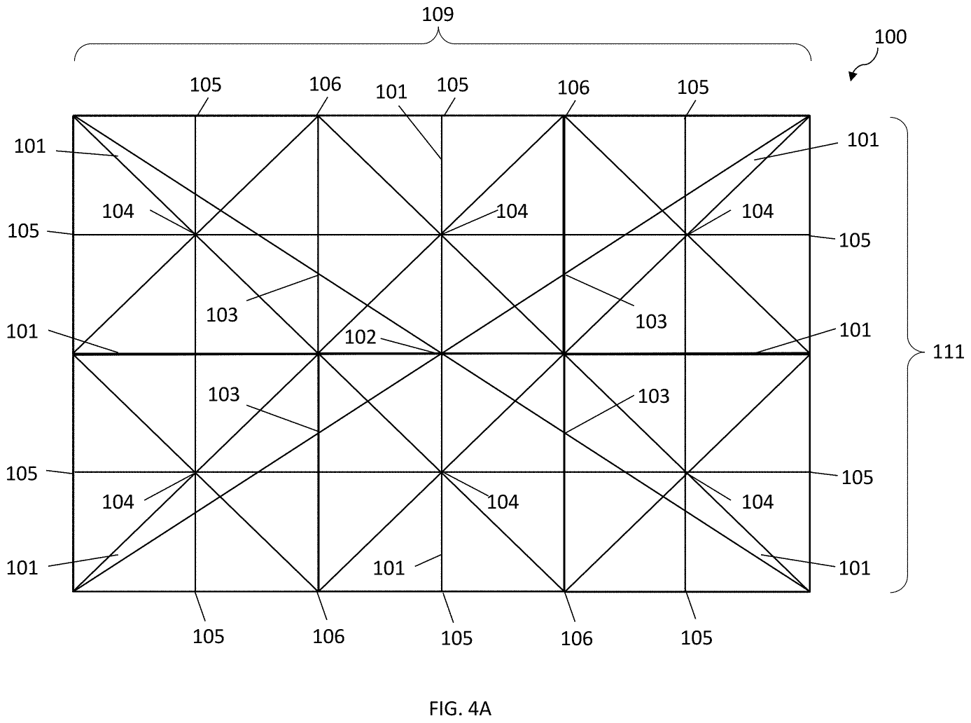

FIG. 2 is a block diagram illustrating an example of a pallet monitoring device 200 coupled to a pallet 202 according to embodiments of the system described herein. Other embodiments of pallet monitoring devices, for example, variations of the pallet monitoring device 200, are possible and are intended to fall within the scope of the invention. FIG. 2 may be considered a relatively high-level functional representation of a pallet monitoring system according to embodiments of the system described herein. More physical aspects of embodiments of the system are described elsewhere herein. The pallet 202 may be any type of pallet, for example, a Euro pallet (e.g., an EPAL 1 pallet 150 described above in relation to FIG. 1). The pallet monitoring device 200 may include any of: an IPU 204, one or more sensors 220, other components or any suitable combination of the foregoing.

The IPU 204 may include any of: a CPU 208, one or more network interfaces (i/fs) 206, an integrated ambient light sensor 214, a movement sensor 216, one or more climate sensors 210, a TPM 212 and a timer component 213. The CPU 208 may be an ARM CPU or other type of CPU, and may be configured with one or more of the following: required processing capabilities and interfaces for the other components of the IPU 204 described herein, an ability to be interrupted by the timer component 213 and by the movement sensor 216, random access memory, and nonvolatile memory (e.g., FLASH) for storage. In some embodiments, the CPU 208 may be implemented using an STM32L4 96 VG CPU or a similar CPU made available by STMicroelectronics. The timer component 213 may provide a clock for the IPU 204, and to the CPU 208 specifically. The timer component 213 may be configured to provide the clock at any of a variety of frequencies, for example, at 32 KHz or lower. The frequency of the clock may be selected to balance a variety of factors, including, for example, cost, resource consumption (including power consumption) and highest desired frequency of operation.

The one or more network interfaces 206 may include a plurality of types of network interfaces, each interface configured to implement one or more particular technologies to enable communications with one or more types of networks. For example, the one or more network interfaces 206 may include one or more cellular communication interfaces enabling communications with cellular networks, and may be configured with technologies such as, for example, Long-term Evolution (LTE) and LTE FDD/TDD (4G) and derivatives thereof such as LTE narrowband (5G) and other 5G derivatives, HSPA (UMTS, 3G), EDGE/GSM (2G) or CDMA technologies. Cellular communications may be used as one possible form of communication to enable a pallet monitoring device to communicate with one or more other devices of a pallet management network, such as systems described elsewhere herein, to perform any of a variety of functions. Such functions may include detection of geographic location of a pallet (i.e., to which a pallet monitoring device is affixed or otherwise coupled), including detecting a change in location from one cell of a cellular network to another cell, and a relative location of a pallet within a cell, for example, a radial distance from the cell phone base station. The one or more cellular communication interfaces may be, include, or be part of a cellular modem.

The one or more network interfaces 206 may be configured to implement GPS technology, which in some embodiments may be integrated with cellular technology as part of a cellular modem. The network interfaces 206 also may be configured to implement UWB technology if accuracy of indoor location on the order of centimeters is desired, for example using one or more MYNXG® d3/MYNXG° FCR 3 gateways/modems available from MyOmega Systems GmbH and its MYNXG Technology GmbH, MYNXG Product GmBH, MYNXG Services GmbH and further possible affiliates having offices in Nuremberg, Germany, (hereinafter “MyOmega”). Network interfaces 206 further may be configured to implement Wi-Fi technology, e.g., in accordance with one or more 802.11 standards, which may save communication cost. This cost savings may be more desirable for larger fleets of pallets, for example. The Wi-Fi technology may be used to connect with hotspots at various locations and during various states of a pallet lifecycle described in more detail elsewhere herein, and may serve as an option for establishing a communication path within a pallet management network, for example, as an alternative, or in addition to a cellular communication path.

The one or more network interfaces 206 may be configured to implement Industrial, Scientific and Medical (ISM) band technology also referenced as Sub-1-GHz Technology within European Union directives), e.g., 6LoWPAN, ZigBee, Lora and or Sigfox, to establish Wide Area Low Power links, having a range of, for example, 3000 meters, or perhaps more. In some embodiments, an ISM technology may be employed with 802.15.4 PHY, 6 LoWPAN Layer 2 and MAC and CoAP protocol via ISM band.

The movement sensor 216 (e.g., an accelerometer) may be configured to detect and measure three-dimensional (e.g., relative to three axes) acceleration movement, and may use an optional gyroscope or artificial horizon, to detect the movement of the pallet 202. That is, the movement sensor 216 may be configured to detect relative abrupt movement, e.g., as a result of a sudden acceleration, in contrast to a more general change in geographic location. Such a movement may occur, e.g., as a result of a sudden stop, an accident, falling from a shelf, tipping over, being manually jostled, a hole in a road, a deformation of a railroad rail, wind turbulence impacting an airplane, stormy seas, etc. The movement sensor 216 may be used in combination with interrupt functionality of the CPU 208 to implement a deep sleep mode of operation, as described in more detail elsewhere herein.

The one or more climate sensors 210 may be configured to measure any of a variety or climate conditions of the pallet monitoring device 200, e.g., inside a cavity of the pallet monitoring device or inside a housing containing one or more components of the pallet monitoring device , for example, the IPU 204 and/or one or more sensors 220. Such climate conditions may include any of: temperature, air humidity, air pressure, other climate conditions or any suitable combination thereof. While climate conditions may be measured inside a housing or cavity within the pallet monitoring device, in some embodiments the pallet monitoring device may include a pressure compensation membrane (e.g., a climate pressure equalization gasket), and measurement cycles may be ultra-short such that the measured climate conditions are valid for an environment in the immediate vicinity (e.g., surrounding) the pallet monitoring device as well. While the one or more climate sensors 210 are illustrated as being part of the IPU 204, one or more additional climate sensors may be external to the IPU 204, within the pallet monitoring device 200 (e.g., as one or more sensors 220) or external thereto. Climate sensors located external to the IPU 204 may be linked through one or more M12.8 connector-based digital and/or analog interfaces, or other contacts such as Phoenix Contacts PCB terminal blocks, and may measure any of a variety of climate conditions, including but not limited to: temperature, humidity and pressure or other climate conditions of a pallet, the loads carried thereon (e.g., liquid, solid, air) and/or ambient air external to the pallet.

The integrated ambient light sensor 214 may serve to ensure the integrity of a cavity, housing and/or electronics of the pallet monitoring device, including providing mechanical dust and water detection. The sensor 214 may enable detection of evidence of tampering and potential damage, and thus provide damage control to protect electronics of the pallet monitoring device 200.

The Trusted Platform Module (TPM) 212 may be used to encrypt data and to protect the integrity of the IPU 204. The TPM 212 may be used for any of a variety of functions such as, for example, creation of data for, and storage of credentials and secrets to secure, communication with one or more networks (e.g., any of the networks described herein); creation of TPM objects, which are special encrypted data stored in the nonvolatile memory outside the TPM, that can only be decrypted through the TPM; creation of data to be communicated and stored as part of transaction records (e.g., blockchain records) or registers, signing of files to secure the integrity and authenticity of services, e.g., services described herein; enablement of functions like Over-the-Air (OtA) update of firmware, software and parameters of the pallet monitoring device 200; other functions; and any suitable combination of the foregoing.

The IPU 204 may include digital and/or analog interfaces, which may utilize an M12.8 connector to communicate, or other contacts such as Phoenix Contacts PCB terminal blocks, with the one or more sensors 220. Such interfaces also may utilize I²C busses as well. The one or more sensors 220 may include any of the following: pressure sensors (e.g., included in hydraulic mats) that are used to detect pressure imposed on the pallet 202 by a load; temperature array sensors to identify temperature profiles (e.g., the Melexis MLX 90621 Infrared sensor array made available from Melexis of Belgium, which provides 16×4 pixels); strain gauge sensors to identify forces imposed on a pallet by a load (e.g., by measuring the strain imposed by load on the pallet monitoring device affixed atop the pallet, between the load and the pallet), for example, to determine a weight of a load borne by a pallet, RFID UHF readers to read signals transmitted by RFID tags/transponders on a pallet or load item; optical code readers to read one- or two-dimensional bar codes (e.g., Quick Response Code (QRCs) or the like labeling a pallet or load item, or any suitable combination of the foregoing. For simplicity of reference, the term “RFID/QRC reader” or “reader” may be used herein to mean an RFID UHF reader and/or an optical reader, which could be a QRC reader. That is, an RFID/QRC reader or reader may include an RFID reader, a QRC reader, another type of optical code reader, or any combination of the foregoing. In some embodiments, the QRC/RFID labels on pallets and/or load items include a QRC code and/or serial numbers. In some embodiments, one or more RFID readers may be implemented using an integrated circuit (IC) made available from NXP semiconductors, for example, the SL53S4011_4021 model. The coding and communication of RFID/QRC information can be done in many forms, including, for example, using one or more of: ISO 18.000 part 6-compliant RFID UHF tags; UHF EPC Global Generation-compliant communications; 2; GS1-compliant bar codes; and GS1-compliant QRC codes.

The IPU may contain in addition RFID NFC reader to enable payment applications and access control applications. Such RFID NFC Reader may also be connected via the I² C interfaces and enable services like a payment transaction when a pallet is received. In such a case, a Credit Card or an Mobile Phone (Smartphone) with NFC payment functions (e.g. Apple® Payment) could communicate via an NFC point marked at the pallet. Another type of service is an interaction with Access Management Systems to register/deregister activities executed by a dedicated person at the pallet, who, for example, may validate that a detailed inspection took place.

In some embodiments, the IPU 202 may be configured to correct interference, for example, g-forces, caused by movement, and thereby avoid taking unnecessary action (e.g., waking up from an idle state, as described in more detail elsewhere herein).

The IPU 204 may be implemented using one or more software components, including an operating system, of a MYNXG® TracoSense®/MYNXG® Sense MCO sensor platform made available by MyOmega and MYNXG affiliates, and the pallet monitoring device 200 may be implemented as part of, or include a MYNXG® TracoSense® IBC™/MYNXG® MCO/MCE IBC™ product made available from MyOmega and MYNXG affiliates.

Although not illustrated in FIG. 2, the pallet monitoring device 200 also may include one or more mobile phone vibrators or the like and microphones, which may be used, for example, for detection of damage to the pallet 202 or pallet monitoring device 200, and, in combination with logic (e.g., hardware, firmware or software) within the IPU 204, to determine a system health of the pallet or pallet monitoring device by analyzing resonances and frequencies of impact sound on the pallet 202 using, for example, proprietary Detailed Sampling Mode (DSM) techniques available from MyOmega and MYNXG affiliates or any other appropriate technique, including conventional techniques for analyzing resonances and frequencies of impact sound. For example, a microphone may be connected via digital/analog M12.8 connectors, or other contacts such as Phoenix Contacts PCB terminal blocks, to the pallet monitoring device 200 and/or integrated within the pallet monitoring device 200 (e.g., within the IPU 204). Sound waves may be caused by acoustic stimulation of the pallet, and DSM techniques may be employed to sample and analyze the sound waves.

Although not illustrated in FIG. 2, the pallet monitoring device 200 also may include one or more cameras, which may be used to monitor and record the current load of the pallet 202, where such information may be used by image-processing logic, e.g., within the IPU 204 and/or a gateway, server or other elements of a pallet management network described herein to control the loading or unloading of items onto/from the pallet 202. The pallet monitoring device 200 may include, within the IPU 204 or otherwise, one or more batteries or accumulators, for example, a Lithium ion battery, and/or interfaces thereto. The pallet monitoring device 200 also may include one or more interfaces that enable the battery or accumulator to be charged, in particular the interface may be a coil for wireless contactless charging, and a wireless receiver to control the wireless charging of the battery/accumulator of the PDM 2014. The pallet monitoring device 200 also may include other interfaces, for example, one or more interfaces for display devices, e.g., an e-Paper interface.

One or more components of the pallet monitoring device 200, including the IPU 204 and/or components thereof, may be implemented in hardware, firmware, software or a combination thereof, for example, on a PCB. In such embodiments, the PCB may be affixed to one or more M12.8 connectors, for example, a male and female M12.8 connector, or other contacts such as Phoenix Contacts PCB terminal blocks. A battery or accumulator of the pallet monitoring device 200 may be charged via an M12.8 connector, and external components may communicate with components of the pallet monitoring device 200 via one or more M12.8 connectors as described elsewhere herein. The pallet monitoring device 200 may include one or more antennas corresponding to the one or more communication technologies that may be included in the pallet monitoring device 200 as described elsewhere herein. Each antenna may be integrated, if suitable, within a PCB in embodiments including a PCB, for example, in the IPU 204, or may be physically connected to the PCB and/or a housing thereof. For example, one or more antennas may be implemented as an integrated foil antenna, glued to the PCB or a housing of one or more components of the pallet monitoring device 200.

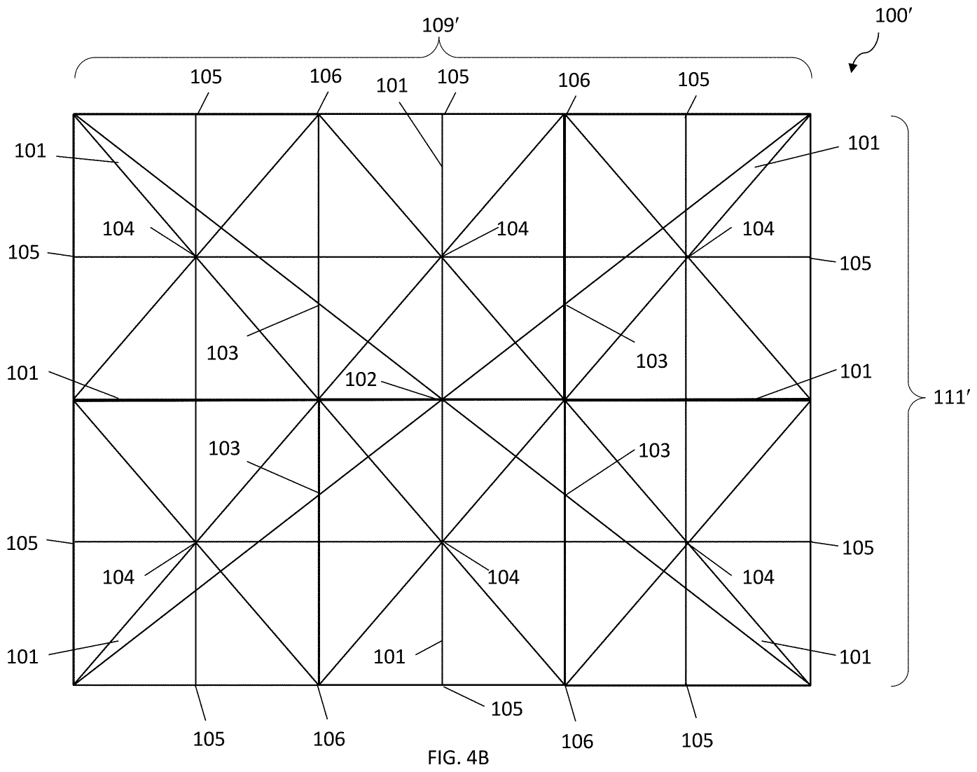

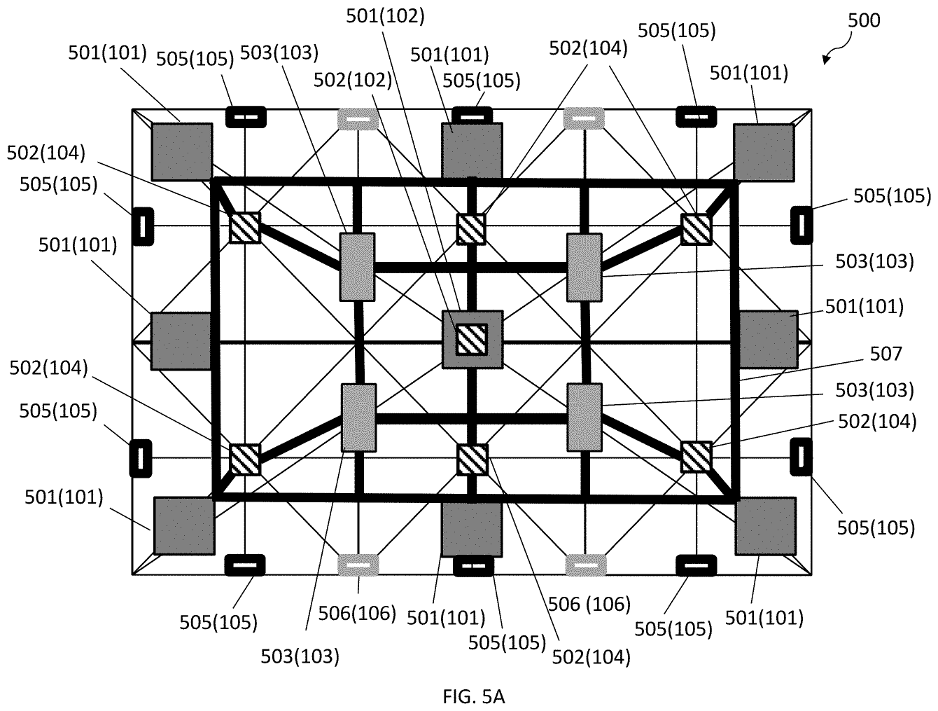

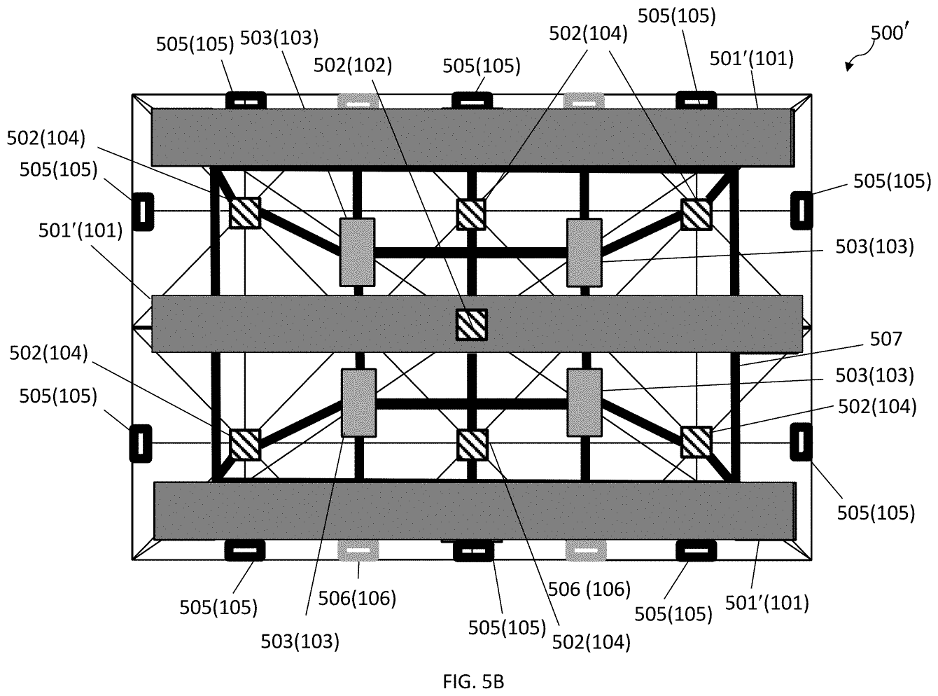

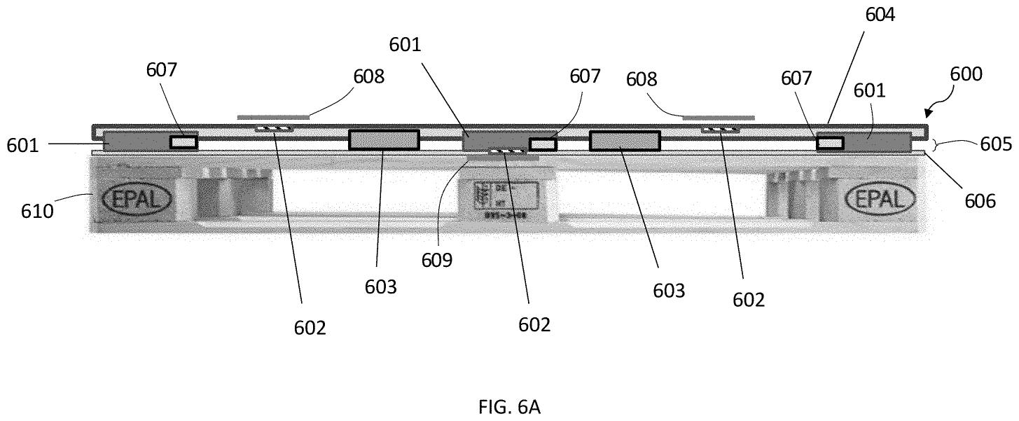

Pallets are typically used to carry packages or containers of goods during transport, storage or sale (e.g., in a store or other market) including, for example, kegs, barrels, other rigid containers (e.g., KLTs) and/or bags, each of which contain one or more types of materials, including liquids and solids of various form. Kegs, for example, are barrels that may be used to transport food and beverages, for example, beer. Various standard keg sizes have been defined including, for example, DIN-kegs and Euro-kegs in Europe, having outside diameters ranging from 363 mm to 408 mm, depending on the volume capacity of the kegs. A typical loading arrangement for DIN- or Euro-kegs on an EPAL 1 pallet is illustrated in FIG. 3A, in which six kegs are arranged in a 2×3 pattern.

Steel drums or “drums” are barrels that may be used to transport oils and chemicals, for example. Various standard steel drum sizes have been defined, including a 200-liter (i.e., 55-gallon) drum as defined by ANSI, which has an outside diameter (at various positions along its height) ranging between 572 mm and 597 mm. Two ANSI-compliant 200-liter drums can fit side-by-side on an EPAL 1 pallet. When carried on an EPAL 1 pallet, the position of an ANSI-compliant 200-liter drum is less predictable that the arrangement of DIN- or Euro-kegs, as there is an extra ˜200 mm of width of the pallet that can be used. Three ANSI-compliant 200-liter drums can fit on an EPAL 2 (1000 mm×1200 mm) pallet, for example, as illustrated in FIG. 3B.

Various types of bags of various sizes may be loaded on pallets, e.g., in stacks of layers. For example, FIG. 3C shows a stack of 800 mm×400 mm bags (e.g., of sugar), three bags per layer, on an EPAL 1 pallet; and FIG. 3D shows a stack of 600 mm×400 mm bags (e.g., cement), five bags per layer, loaded on an EPAL 2 pallet.

Standardized KLTs come in various sizes. For each KLT size, the number of KLTs that can fit per layer of a stack on a pallet may vary, for example, as illustrated in Table 1 for an EPAL 1 pallet (1200×1600 mm). For example, FIG. 3E shows a three-layer stack of KLTs on an EPAL 1 pallet.

TABLE 1
KLTs per layer of stack on EPAL 1 Pallet

| KLT Type | Dimensions | Arrangement | Total Per Layer |
|---|---|---|---|
| KLT 2115 | 150 × 200 × 148 mm | 8 × 4 | 32 |
| KLT 3215 | 300 × 200 × 148 mm | 6 + 4 + 6 | 16 |
| KLT 4115 | 150 × 400 × 148 mm | 8 × 2 | 16 |
| KLT 4315 | 300 × 400 × 148 mm | 4 × 2 | 8 |

In some embodiments of a pallet monitoring device, sensors and other components (e.g., the IPU 204) of the pallet monitoring device are arranged to accommodate various uses cases of a pallet, i.e., to function satisfactorily for various types of loads, for example, one or more of the use cases described herein for kegs, drums, bags, KLT or other types of containers or packaging. For example, the sensors may be arranged at certain positions within the pallet monitoring device to enable detection of one or more properties of various types and arrangements of loads on a pallet, including but not limited to the presence of one or more items of a load, the weight of the load, and perhaps the position of load items.

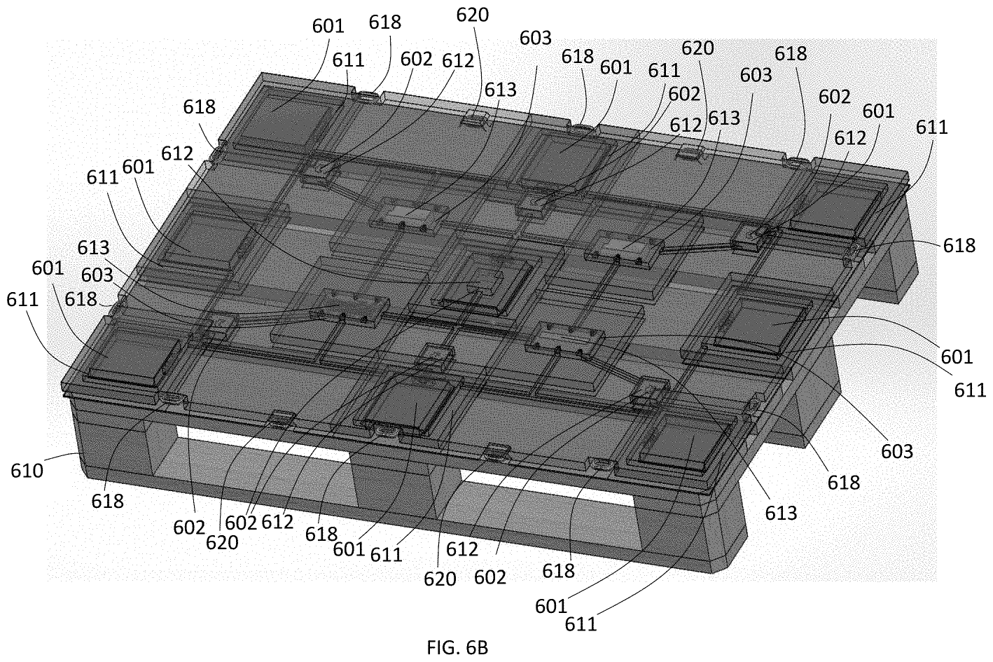

In some embodiments of the system described herein, an arrangement of one or more components of a pallet monitoring device may be based, at least in part on a pre-defined grid, such as, for example, a grid 100 or grid 100′ described in relation to FIGS. 4A and 4B, respectively.

FIG. 4A is a schematic illustrating an example of a grid 100 for determining an arrangement of one or more components of a pallet monitoring device, according to embodiments of the system described herein. Other embodiments of a grid for determining an arrangement of one or more components of a pallet monitoring device, for example, variations of grid 100, are possible and are intended to fall within the scope of the invention. FIG. 4A may be a grid defined for an EPAL 1 pallet, and may have a length 109 and a width 111 based at least in part on the length and width dimensions of an EPAL 1 pallet (1200 mm×800 mm), respectively. FIG. 4B represents another embodiment of a grid, grid 100′, for determining an arrangement of one or more components of a pallet monitoring device. Grid 100′ may have a different length 109′ and width 111′ than the length 109 and the width 111 of the grid 100. For example, the grid 100′ may be a grid defined for an EPAL 2 pallet (1200×1000 mm). The following description of the embodiment of the grid 100 applies analogously to the embodiment of the grid 100′, taking into consideration the different lengths and widths, and the relative differences in positions of components as a result thereof.

Various points on the grid 100 correspond to locations of components of a pallet monitoring device designed therefrom. For example, the grid point 102 may correspond to a location of a center point on top of a center block of a pallet (e.g., a 9-block Euro pallet). In some embodiments of the system described herein, a pallet monitoring device may be permanently affixed to a pallet, for example, using glue or some other adhesive agent of fastening mechanism. In other embodiments, a pallet monitoring device may be temporarily fixed to a pallet, for example using straps. In such embodiments, a QRC and/or RFID (UHF)/or RFID (NFC) label may be affixed to a top of the center block of the pallet. Accordingly, it may desirable to locate an RFID/QRC reader at the grid point 102 of a pallet monitoring device, as described in more detail elsewhere, and to include a cavity (“reader cavity”) within the pallet monitoring device at a location corresponding to the grid point 102 to accommodate an RFID/QRC reader. For example, an RFID reader of 1 mm in height may be placed at the location of the grid point 102. If an optical code reader is included in a pallet monitoring device, the pallet monitoring device may be configured (e.g., with an opening or translucent material) to allow the optical code reader to see a label on a center block.

Each grid points 101 may represent the center point of a block other than the center block (e.g., the 8 other blocks of a 9-block pallet). In some embodiments of the system described herein, one or more sensors for detecting forces (e.g., pressure sensors or strain gauges) from which a weight of a load can be determined may be placed at locations corresponding to the grid points 101. For example, as described in more detail elsewhere herein, such sensors may be embedded in hydraulic mats that may be placed at locations within a pallet monitoring device corresponding to the grid points 101, and it may be desirable to include a cavity (“hydraulic mat cavity”) within the pallet monitoring device at each location corresponding to the grid point 101 to accommodate a hydraulic mat. In some embodiments in which hydraulic mats are used, it may not be possible, or at least not desirable, to place a hydraulic mat near a side of a pallet, in which case the hydraulic mat may be placed so that its sides are no closer than a certain predefined distance (e.g., 30 mm) from a side of the pallet. It may be desirable to place such sensors and/or hydraulic mats as near as possible to blocks of a pallet as the blocks will bear the load placed on the top boards of a pallet and thus provide a more accurate representation of weight than other locations on a top side of a pallet, and because the blocks offer more support for the sensors and/or hydraulic mats themselves than the boards of a pallet.

Grid points 104 may represent locations (“reader points”) at which it may be desirable to locate RFID/QRC readers to determining the presence and number of items of a load, and to include reader cavities within the pallet monitoring device to accommodate the RFID (UHF)/QRC readers. The location of reader points may have been determined based on the anticipated potential loads of a pallet, for example, kegs, drums, KLTs, bags and other items of various know sizes and shapes. For example, the grid 100 may correspond to an EPAL 1 pallet and the reader points 104 may correspond to anticipated locations of kegs thereon, e.g., as illustrated in FIG. 3A. While such positions of grid points may be ideal for kegs, they also may be acceptable for drums, bags, KLTs and other items, as the readers may be configured to have a range capable of detecting other items, even if not directly above the reader. It should be appreciated that the location of reader points may be different, and may be designed to be more ideal for the anticipated locations of other types of load items. In some embodiments, to provide for the use of optical readers, at the grid points 104 the pallet monitoring device may be configured (e.g., with an opening or translucent material) to provide an optical line of sight from the reader to the underside of load items. For example, kegs may have QRC labels or other types of bar codes or markings affixed to their bottoms that could be read by an optical code reader placed a location of a pallet monitoring device corresponding to the grid points 104 of an EPAL 1 pallet.

Grid points 105 may represent locations (“load fixation points”) for placing elements for affixing the pallet monitoring device to a load of a pallet. As the pallet monitoring device will be situated between a pallet and a load of the pallet, it may not be possible, or at least not desirable, to affix the load to the pallet, in which case the load may be affixed to the pallet monitoring device. This may be accomplished, for example, by placing strapping loops at locations of a pallet monitoring device corresponding to the grid points 105 through which straps may be fed to fasten a load to the pallet monitoring device. To reduce the likelihood of a load interfering with use of the load strapping loops, it may be desirable to locate the strapping loops as close to the edge of a pallet and edge of a pallet monitoring device as possible, as reflected by the locations of the grid points 105.

Grid points 106 may represent locations (“pallet fixation points”) for placing elements for affixing the pallet monitoring device to the pallet itself. To reduce the likelihood of a load interfering with use of the pallet strapping loops, it may be desirable to locate the strapping loops as close to the edge of a pallet and edge of a pallet monitoring device as possible, as reflected by the locations of the grid points 106.

Grid points 103 may represent locations (“cavity points”) corresponding to locations of a pallet monitoring device at which it may desirable to house electronics or other components of a pallet monitoring device, for example, an IPU (204), power source (e.g., battery or inductive charger), antennas, or other types of sensors, as described in more detail elsewhere herein.

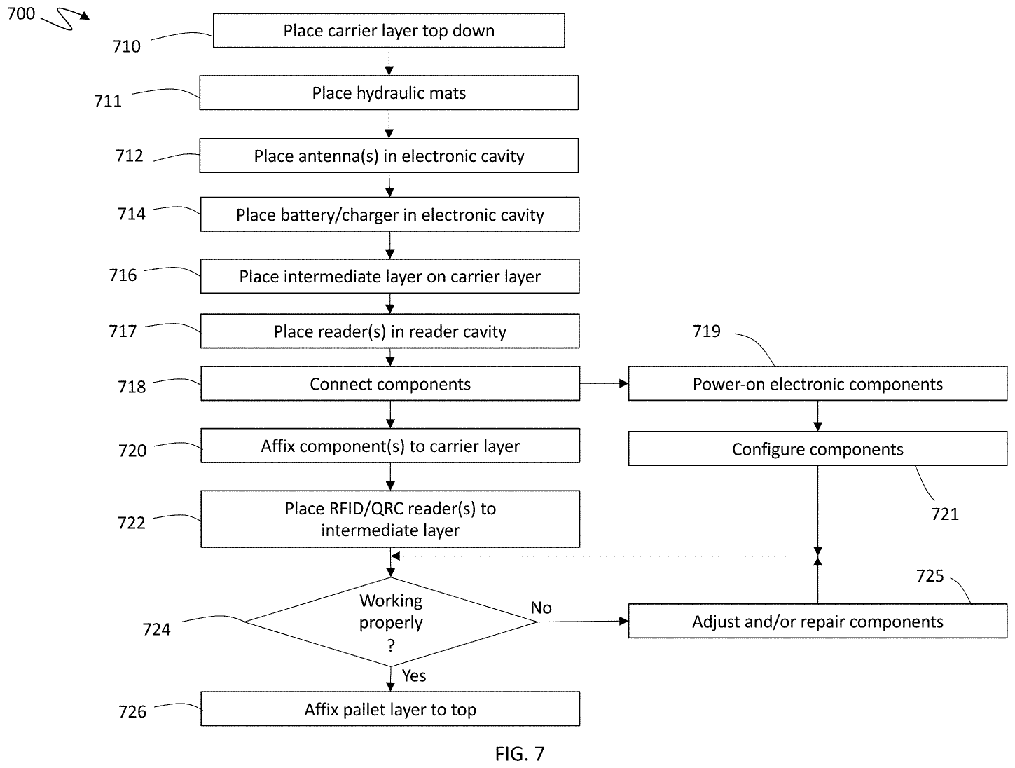

FIG. 5A is a block diagram illustrating an example of a pallet monitoring device 500 according to embodiments of the system described herein, superimposed over a schematic of a grid (e.g., the grid 100) for determining an arrangement of one or more components of the pallet monitoring device 500. Other embodiments of a pallet monitoring device, for example, variations of the pallet monitoring device 500, including a pallet monitoring device 500′ described in relation to FIG. 5B, are possible and are intended to fall within the scope of the invention.

The pallet monitoring device 500 may include: one or more RFID-(NFC)/RFID (UHF)/QRC readers 502 (e.g., 40×40 mm), as described in more detail elsewhere herein, at a location corresponding to the center point 102 of the grid 100; one or more hydraulic mats 501 (e.g., 100×100 mm) at one or more locations corresponding to the sensor points 101, where each of the hydraulic mats 501 may include a pressure sensor for sensing pressure (e.g., fluid pressure) within the hydraulic mat; one or more components (e.g., IPUs, power sources, antennas) 503 at one or more locations corresponding to the cavity points 103 (e.g., 120×60 mm); one or more one or more RFID (UHF)/QRC readers 502 at one or more locations corresponding to the reader points 104; one or more load strapping loops 505 (e.g., 42 mm) at locations corresponding to the one or more load fixation points 105; one or more pallet strapping loops 506 (e.g., 42 mm) at locations corresponding to the one or more pallet fixation points 106; and one or more channels 507 to accommodate electrical or optical connections between one or more components (e.g., IPU, RFID/QRC readers, sensors, power source) of the pallet monitoring device. Each of the one or more RFID(NFC) and the one or more RFID (UHF) /QRC readers 502 may be embedded within a respective reader cavity within the pallet monitoring device, each such cavity also being located at a position corresponding to a center point 101 and/or reader point 104 of grid 100; and each of the one or more hydraulic mats 501 may be embedded within a respective hydraulic mat cavity of the pallet monitoring device, the cavity also being located at a position corresponding to a sensor point 101 of grid 100.

FIG. 5B is a block diagram illustrating an example of a pallet monitoring device 500′ according to embodiments of the system described herein, superimposed over a schematic of a grid (e.g., the grid 100) for determining an arrangement of one or more components of the pallet monitoring device 500′. In some embodiments, the only difference between the pallet monitoring device 500 and the pallet monitoring device 500′ is that the pallet monitoring device 500 includes 9 hydraulic mats 501 and the pallet monitoring device 500′ includes 3 hydraulic mats 501′, for example, of greater length than the hydraulic mats 501.

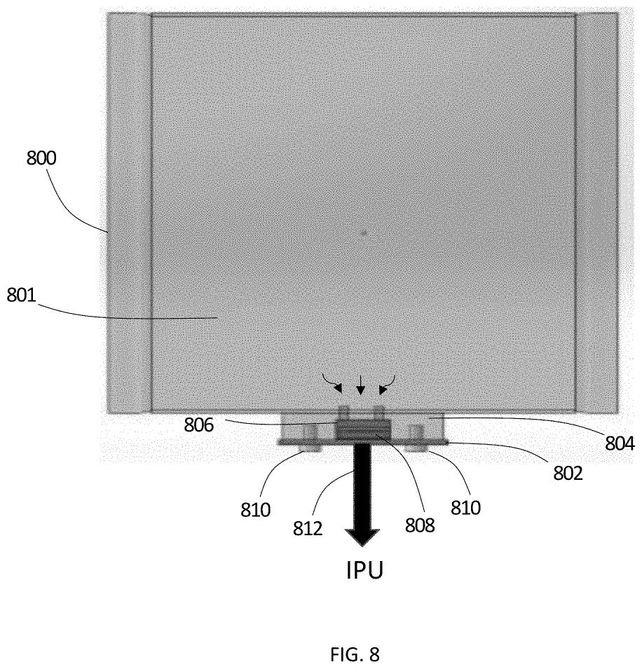

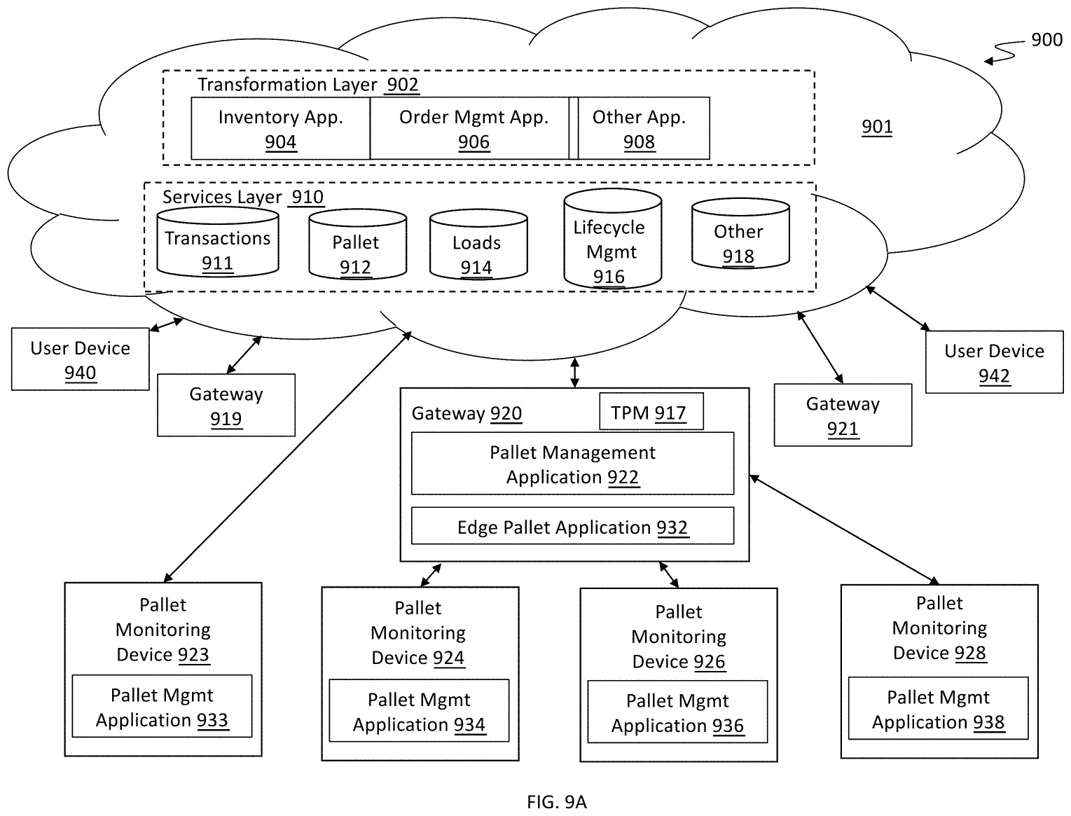

In some embodiments of the system described herein, a pallet monitoring device may include, e.g., be constructed from, multiple layers. FIGS. 6A and 6B illustrate an example of a pallet monitoring device 600 (e.g., the pallet monitoring device 500) having multiple layers, from a side view and perspective view, respectively, which is coupled to a pallet 610 (e.g., an EPAL 1 pallet). The perspective view of the pallet monitoring device 600 illustrated in FIG. 6B shows components of the pallet monitoring device 600 as being made visible as a section view to show the construction principle and illustrate interior components that otherwise may not be visible from the perspective view. However, the invention is not so limited and it may be desirable that such components are made of opaque robust plastic materials. Other examples of a multi-layered pallet monitoring device, for example, variations of pallet monitoring device 600 are possible, and are intended to fall within the scope of the invention. For example, various components may be implemented in a layer other than the layer for which implementation illustrated and/or described herein, or in combination with one or more other layers.

The pallet monitoring device 600 may include a plurality of hydraulic mats 601, each of which may be a hydraulic mat 501 and may include an embedded pressure sensor 607. The pallet monitoring device 600 also may include a plurality of RFID (NFC)/RFID (UHF)/QRC readers 602, each of which may be a reader 502, and may be configured to read an RFID (UHF) RFID/QRC label 608 or an RFID (NFC)/RFID (UHF)/QRC label 609 on a load item or center block of a pallet, respectively. It should be appreciated that multiple readers may detect a same load item, and is some cases three or more readers may detect a same load item. The IPU or other component(s) of the pallet monitoring device, and/or one or more components of a pallet management network, individually or in combination, may be configured to determine when multiple RFIDs have detected a same item. The ability to make such a determination may be used to ensure that an accurate count of items is maintained, i.e., that no loaded item is counted twice. Further, information detected from multiple sensors may be used to determine a location of a load item on a pallet, for example, using triangulation techniques or other techniques based on strengths of signals detected from RFID tags on the items and known properties of the RFID readers.

The pallet monitoring device 600 may include a plurality of layers, including a carrier layer 604, a pallet layer 606 and an intermediate layer 605 between the carrier layer 604 and the pallet layer 606. The carrier layer 604 may include: a plurality (e.g., 9 or 3) hydraulic mat cavities 611 to accommodate a plurality of hydraulic mats 601; a plurality (e.g., 4) of electronics cavities 603 to accommodate electronics 613 (e.g., IPU, power source, etc.) and/or other components; a plurality (e.g., 7) of reader cavities 612 to accommodate RFID/QRC readers 602; a plurality (e.g., 10) of load strapping loops 618; other elements; or any suitable combination of the foregoing. The load strapping loops 618 may be created by overmoulding a link of a chain to the carrier layer 604 or by other means.

The carrier layer 604 may provide one or more functions, including but not limited to: supporting the placement of components on or within the pallet monitoring device during assembly; providing fixtures, for example, snap hooks or threaded screws, for PCB assembly, including fixtures for an IPU, RFID/QRC readers, hydraulic mat guides, and fixtures for batteries and antennas; carrying the weight of load items placed on a top surface of the pallet monitoring device; providing housing for components of the pallet monitoring device (e.g., perhaps in combination with one or more other layers of the pallet monitoring device), for example, that meets certain regulatory requirements, e.g., EN 60529-IP68. The carrier layer 604 may: have a height of 15.4 mm; have an ultra-robust outer surface for contacting loads; and be constructed as light as possible including supportive structures. One or more surfaces of the carrier layer 604 may have a different color than a surface of the pallet layer 606 to more easily distinguish the two layers from one another, and may include one or more labels, brandings or markings to help identify the carrier layer 604 and/or the location of one or more components within the pallet monitoring device. For example, the carrier layer 604 may include a marker indicating where to place a battery charger or accumulator (acc) charger or a wireless inductive charger, for example, at a location corresponding to a cavity with the carrier layer that holds a battery, accumulator or inductively wireless chargeable device.

One or more reader cavities 612 may include snap hooks that, during production of the pallet monitoring device 600, may be used to position RFID(UHF)/RFID (NFC)/QRC readers within the carrier layer 604; and one or more of the hydraulic mat cavities may be configured with guiding walls to support the placing of the hydraulic mat during production of the pallet monitoring device 600. One or more of the electronics cavities 603 may be configured with: snap hooks to support placement of the antennas during production; screw domes or snap hooks for the fixation of an IPU during production; and screw domes to affix batteries or accumulators and minimize side-to-side movement, whereas up-down movement may be dampened with support from the intermediate layer 605.

The pallet layer 606 may be a bottom layer of the pallet monitoring device 600, and may have an ultra-robust surface designed for direct contact with a pallet, and may be designed to have a height of 2 mm or less. The pallet layer 606 may provide one or more of the following mechanical functions: placement of the pallet monitoring device 600 on top of a pallet (e.g., the pallet 610), and have the robustness to handle the rough mechanical stress that may result from direct contact with the pallet; provide housing for one or more components of the pallet monitoring device (e.g., perhaps in combination with one or more other layers of the pallet monitoring device), for example, that meets certain regulatory requirements, e.g., EN 60529-IP68; and serve as a physical interface between the pallet monitoring device and a pallet, for example, by permanent fixation via gluing or more temporary fixation via straps, and may carry one or more elements (e.g., strapping hooks 620) for this function. An inside surface of the pallet layer 606 may allow gluing or ultrasonic welding to a intermediate layer 605, and an outside surface of the pallet layer 606 may allow for permanent or temporary fixation to a pallet. One or more surfaces of the pallet layer 606 may include one or more colors, labels, brandings or markings to help identify the pallet layer 606 and distinguish it from other layers of the pallet monitoring device and/or one side of the pallet layer from another.

The intermediate layer 605 may include, and in some embodiments consist primarily of, one or more materials that may be softer and/or less rigid than materials with which the carrier layer 604 and/or pallet layer 606 are comprised, and may be designed to be as light as possible while still serving its function(s) so as to add as little weight as possible to a load borne by the pallet. The intermediate layer 605 may be configured to have a non-compressed height of around 8 mm or less, which may be less when the intermediate layer 605 is compressed (e.g., by a load). The intermediate layer 605 may include one or more of the following functions: support the placement of one or more components within the pallet monitoring device during assembly; provide housing for one or more components of the pallet monitoring device (e.g., perhaps in combination with one or more other layers of the pallet monitoring device), for example, that meets certain regulatory requirements, e.g., EN 60529-IP68; fixation of one or more components within one of more cavities of the pallet monitoring device (e.g., a battery, accumulator); fixation elements for an RFID(NFC) RFID (UHF)/QRC reader 602 within a reader cavity at a center point that determines an identity of the pallet; provide structures to host hydraulic mats and the RFID/QRC readers 602 at reader points; provide cable channels and fixation points to handle the physical coupling (e.g., cabling) between components of the pallet monitoring device, including, for example, an IPU, one or more sensors (e.g., RFID/QRC readers), hydraulic mats (including, e.g., pressure sensors therein), one or more power sources, antennas, etc.; interfacing the carrier layer 604 to the pallet layer 606; enabling the lifting of the pallet monitoring device from the pallet and rough handling of the affixed combination of a pallet monitoring device and pallet.

The intermediate layer 605 may include a top and/or bottom surface that enables gluing and/or ultrasonic welding of the carrier layer 604 to the pallet layer 606, and may have sides that are water and dust protective, for example in accordance with EN 60529-IP68. In some embodiments, a flexible foil may be mounted/glued/ultrasonic welded on the sides of the pallet to realize water protection pursuant to IP68.

The electronics of the device IPU (613) and the electronics RFID (NFC), RFID (UHF)/QRC reader 602 and the embedded pressure sensor 607 may be potted and the interfaces may carry electronic barriers in particular for the battery and the inductive coil of the wireless charger according to the requirements for hazardous environments such as ATEX/NEC 500/NEC 505.

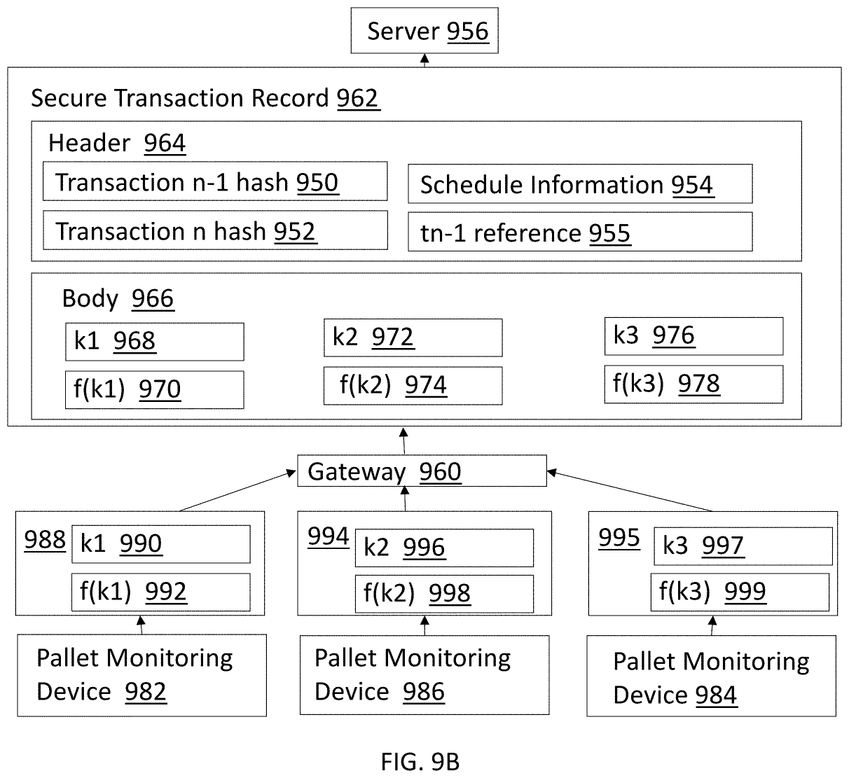

FIG. 7 illustrates an example of a method 700 of producing a pallet monitoring device, according to embodiments of the system described herein. Other methods for producing a pallet monitoring device, for example, variations of method 700, are possible and are intended to fall within the scope of the invention. In step 710, a carrier layer (e.g., the carrier layer 604) may be placed top-down on a surface. That is, while a carrier layer may be the top layer of a pallet monitoring device during use, during production it may be laid top-side down during the step 710. In a step 711, one or more (e.g., 3 or 9) hydraulic mats may be placed within the carrier layer, e.g., within the hydraulic mat cavities of the carrier layer using guides provided within the cavity. In a step 712, one or more antennas (e.g., for communicating with a pallet management network) may be placed within one or more electronic cavities; e.g., snapped into one or more snap hooks. In a step 714, one or more batteries and/or accumulators may be placed within an electronics cavity of the carrier layer, for example, using screw domes. In a step 716, an intermediate layer (e.g., the intermediate layer 605) may be placed on the carrier layer. For example, the intermediate layer may be affixed (at one or more locations) to the carrier layer, e.g., using glue.

In a step 717, one or more readers may be placed in one or more reader cavities of the carrier layer, for example, using one or more snap hooks. In a step 718, one or more components may be interconnected. For example, an IPU, readers, power sources, antennas, pressure sensors (e.g., within hydraulic mats), an RFID (UHF)/QRC Reader etc. may be connected using cables, cable tree and/or other elements. Following the step 718, in parallel to affixing one or more components (e.g., an IPU, readers) to the carrier layer in a step 720 and placing one or more readers (e.g., one or more readers at the center point for reading an ID of a pallet from a center block) in the intermediate layer in a step 720, electronic components (e.g., IPU, readers, sensors) may be powered on in a step 719 (e.g., using one of the installed power sources e.g. the battery/accumulator or an external power source) and one or more electronic components (e.g., the IPU) configured (e.g., programmed).

In a step 724, it may be determined whether the interconnected components are working properly. For example, one or more tests may be run. These tests may include an automated self-test, which initially may be run in response to the IPU being powered on, as well as other automated or user-initiated tests. Programs for performing one or more of the tests or portions thereof may be embodied in software, firmware and/or hardware on the IPU, and/or on one or more of the other interconnected components. Further, programs for performing one or more of the tests or portions thereof may reside on one or more components of a pallet management network (e.g., pallet management network 900 described in more detail elsewhere wherein), and the step 724 may involve the IPU and/or other components communicating with one or more components of the pallet management network. If it is determined in the step 724 that one or more of the components are not working properly (e.g., if one or more tests is failed or produces unsatisfactory results), then in a step 725 one more adjustments may be made, e.g., using programmable parameters of one or more components (e.g., through the IPU), or one or more physical adjustments (e.g., repairs) may be made to one or more components, after which the step 724 may be performed again.

If it is determined in the step 724 that the interconnected components of the pallet monitoring device are working properly, then the TPM (212) of the IPU (204) will receive the personalized secrets to ensure the communication with the pallet management network (900), and the TPM (212) will be locked, then in step 726 a pallet layer (e.g., the pallet layer 606) may be affixed atop the partially assembled pallet monitoring device. For example, the pallet layer may be glued or ultrasonically welded to the intermediate layer and/or carrier layer. It may be desirable to wait until it is determined that the interconnected components are working properly before the pallet layer is affixed, so that any adjustments that need to be made manually can be made while the components are readily accessible, which likely will not be the case after the pallet layer is affixed. Again, while during use of the pallet monitoring device the pallet layer may the bottom layer of the pallet monitoring device, during production it may be placed on top, as the pallet monitoring device may be constructed from the top carrier layer to the bottom pallet layer while situated upside down on a production surface.

Regarding the hydraulic mats, in some embodiments of the system described herein, the pressure inside a hydraulic mat may be calculated using Pascal's law. The pressure inside a non-compressive liquid is equally distributed inside the liquid, and the resulting pressure is vertical to the area. In some embodiments, each hydraulic mat is configured, including its dimensions, to satisfy the following requirements:
For static loads, be able to handle an EPAL 1 safe working load of 1500 kg, and be able to handle an EPAL 1 maximum load, which may result from a stacking of pallets, of 4000 kg;
For dynamic loads, be able to handle an acceleration of up to 5 g of a load item in case of shocks, and typically acceleration of up to 1 g for lifting/stapling; where m is the nominal mass (loaded weight) at the pallet and
The pallet monitoring device and the hydraulic matts are designed to handle the above corner cases, allowing the stacking of 3 pallets on top of each other, with consideration of a nominal weight of 1500 kg per each pallet, as defined by EPAL.
Furthermore, the pallet monitoring device must be able to detect a change of weight of 10 kg.
Have dimensions that support the following use cases:
   Static no movement, m minimum detected (10 kg), sensitivity case for the pallet monitoring device.
   Static no movement, m nominal loaded (1500 kg), products placed on pallet.
   Dynamic, movement (1 g), m nominal loaded (1500 kg), products on pallet normal operation.
   Dynamic, movement (5 g), m nominal loaded (1500 kg), products on pallet crash /drop and cause acceleration of up to 5 g
   Static no movement, m maximum load at the pallet (5500 kg), products@pallet plus 2 pallets stacked.
   Dynamic, movement (1 g), m max (5500 kg), products@pallet plus 3rd pallet is placed.
   Dynamic, movement (5 g), m max (5500 kg), products@pallet plus 3rd pallet crash/drop.

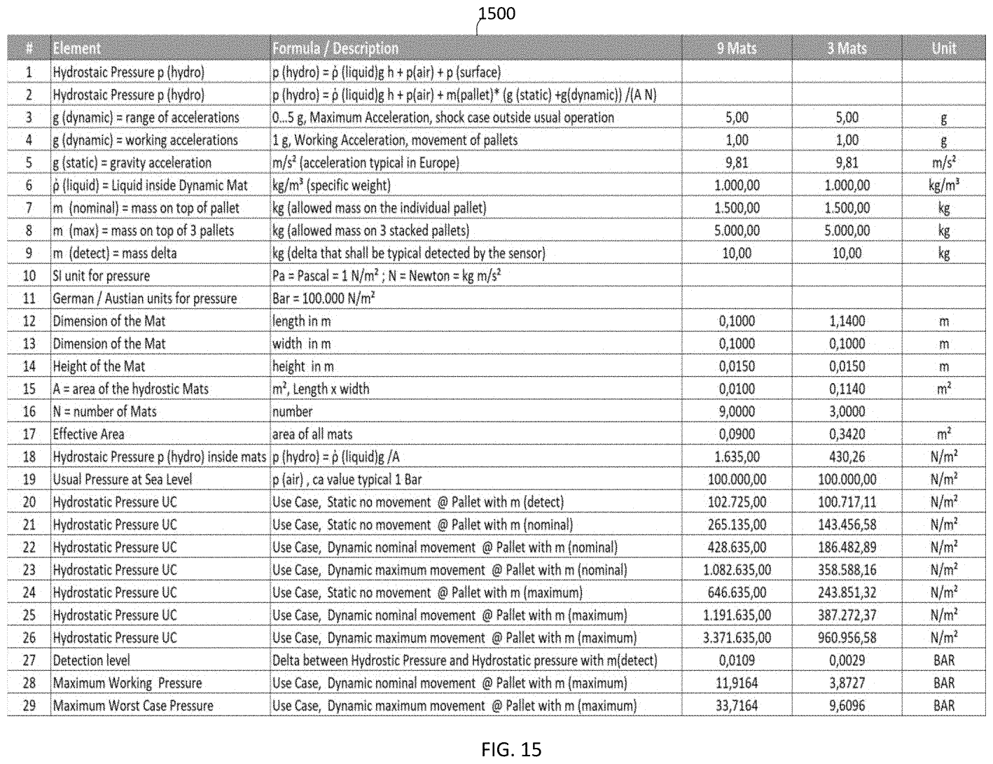

FIG. 15 illustrates a table 1500 having a plurality of entries, each entry specifying a physical property, and threshold values of the property for a 3-hydraulic mat and a 9-hydraulic mat embodiment of a pallet monitoring device. In some embodiments of the system described herein, a pallet monitoring device may have 3 or 9 hydraulic mats in which the hydraulic mats are configured to support the threshold amounts for each property specified in the table 1500.

In some embodiments, to be able to support one or more of the use cases described above and the thresholds set forth in the table 1500, the following conditions may be met:
Hydraulic mats are placed close to the 9 blocks of the pallet;
Area of each hydraulic mat (if 9 mats)=100 mm×100 mm;
Area of each hydraulic mat (if 3 mats)=1140×100 mm;
Height off the hydraulic mat=15 mm;
\grave{ρ} (liquid)=liquid inside hydraulic mat: 1000 kg/m³ (equal or close to water);
Temperature range storage: −40° C. up to 85° C.;
Temperature range operation: −20° C. up to 70° C.;
Liquid inside the hydraulic mat does not freeze at storage; and
Liquid inside the hydraulic mat is non-compressive.

In some embodiments, one or more of the following conditions are met with respect to measurement ranges. A first condition in some embodiments is that a minimum weight that the hydraulic mat shall be able to detect is Static 10 kg. For this condition: it is possible to place the minimum weight at any position of the hydraulic mat; it is assumed that the 10 kg can be a small punctual load; the term punctual means a point as small as possible. The punctual load is placed close to one hydraulic mat and correctly detected. The minimum load is a distributed load and is placed equally between 9 hydraulic mats and is correctly detected; due to meeting the both assumptions, equal distribution and punctual load, the delta of Static 10 kg shall be securely detected (10 liter of consumption).

A second condition in some embodiments is that the maximum dynamic load scenarios are Dynamic 5 g acceleration (equal 5×9.81 m/s²), stacked pallet, 5000 kg, this means that the weight is accelerated with 5 g and the pallet monitoring device and hydraulic matt must manage the resulting forces/pressure. For this second condition: it is assumed that a load of 5000 kg is not punctual as it is unlikely to have a mass of 5000 kg without dimensions and hence the mass is equally distributed over the pallet; hence it is assumed that the maximum load is distributed equally to the pallet area; and the distribution of the forces is managed via the carrier layer.

Other conditions in some embodiments, with respect to dimensioning a pressure sensing element within a hydraulic mat are: a minimum sensitivity with 9 or 3 mats of 0.0109 Bar or 0.0029 Bar, respectively; and a maximum pressure with 9 or 3 mats of 35 Bar or 10 Bar, respectively.

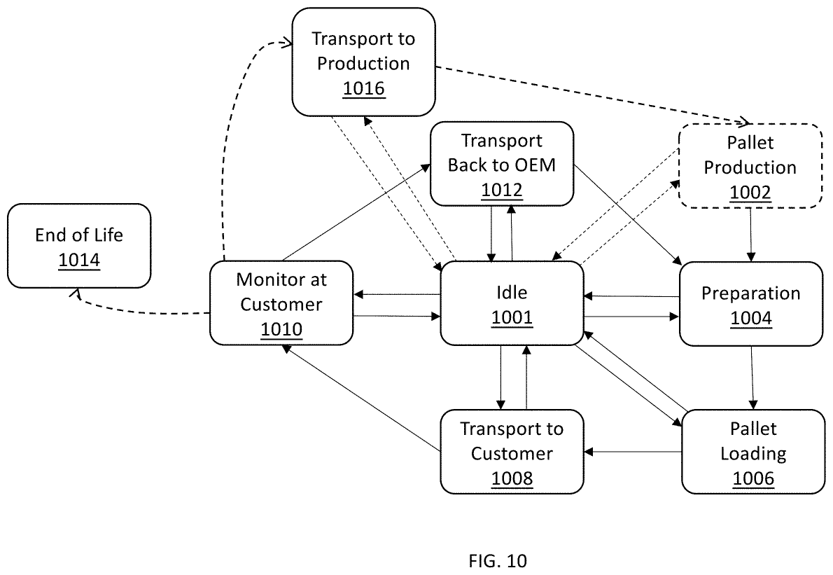

FIG. 8 illustrates an example of hydraulic mat 800 including a pressure sensor 808 (e.g., an Infineon SP27 sensor). The pressure sensor 808 may be connected to a PCB 802, which may be affixed to a sensor fixture 804 of the hydraulic mat 800 by two screws 810. A rubber gasket 806 may be situated between the pressure sensor 808 and the sensor fixture 804, the pressure exerted by the screws 810 against the PCB 802 holding the pressure sensor 808 in place against the gasket 806, and the gasket 806 against the fixture 804. The gasket may include an opening (not shown) that allows fluid to pass from a main body 801 of the hydraulic mat 800 to contact a sensing element (not shown) of the pressure sensor 808 through an opening (not shown) in a housing of the pressure sensor 808, from which the pressure from the fluid may be detected. The PCB may be electrically or optically connected to an electrical or optical connector 812, which may be optically or electrically coupled, directly or indirectly, to other components of a pallet monitoring device, including an IPU, which may be configured to process and analyze the detected fluid pressure as described elsewhere herein.

In some embodiments of the system described herein, the pressure sensors (e.g., the pressure sensor 808) within a hydraulic mat may be an Infineon SP27 Automotive Pressure Sensor, details of which are available at: Infineon.com.sensors (assembly instruction SP27 to Go Kit). In some embodiments, strain gauges and/or other types of sensors may be used to determine the weight of a load, in addition to, or as an alternative to, hydraulic mats with pressure sensors.

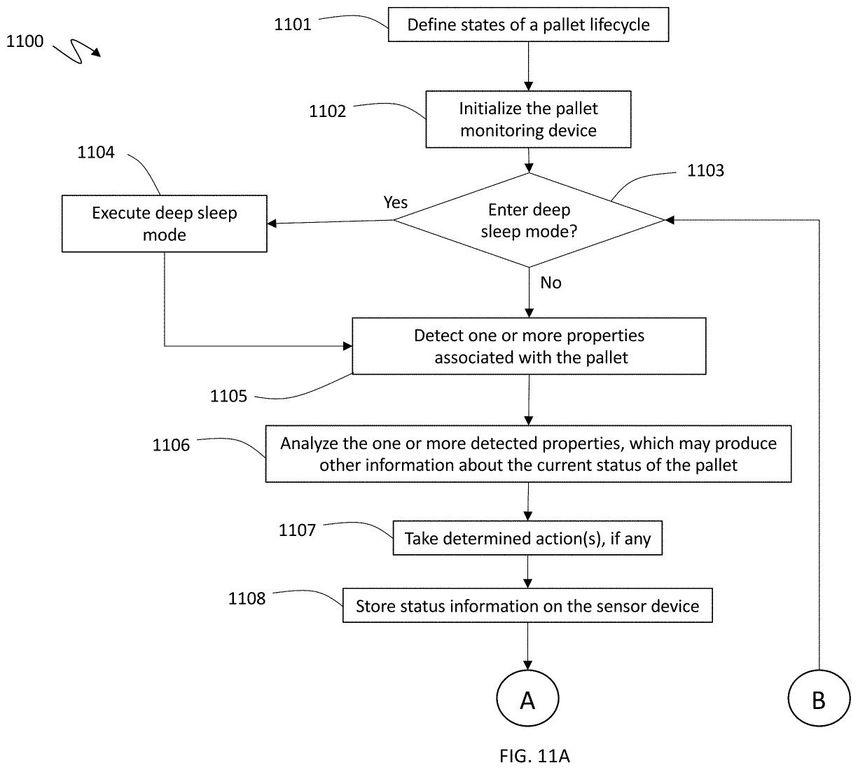

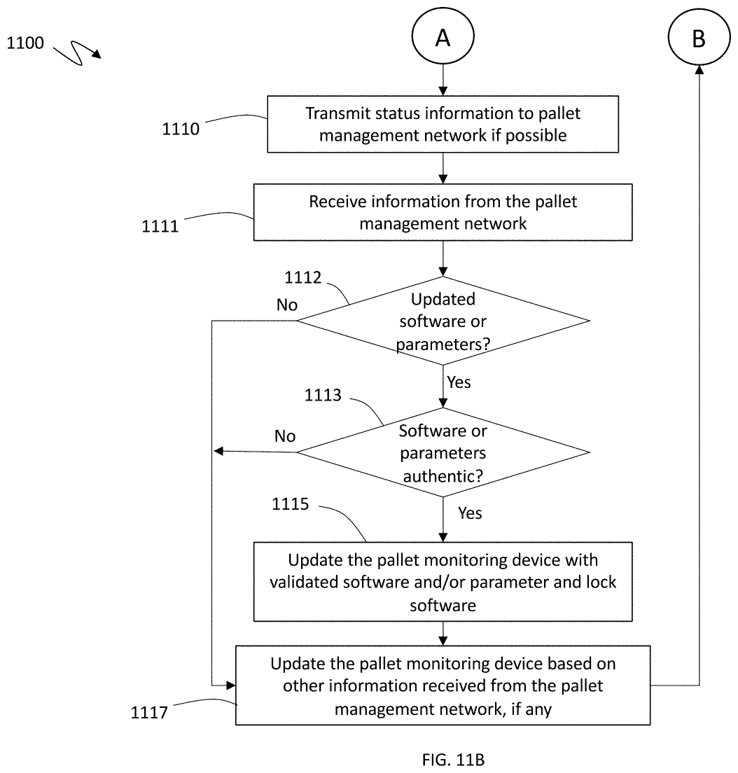

FIG. 9A is a block diagram illustrating an example of the system 900 for remotely monitoring and managing pallets, according to embodiments of the system described herein. Other embodiments of the system for remotely monitoring and managing pallets, for example, variations of the system 900, are possible and are intended to fall within the scope of the invention. The system 900 also may be referred to herein as a pallet management network. The system 900 may include any of: one or more pallet monitoring devices 923, 924, 926 and 928; one or more gateways 919-921; one or more user devices 940, 942, a transformation layer 902, a services layer 910 and other components in a cloud 901; other components; and any suitable combination of the foregoing. It should be appreciated that, while only three gateways and four pallet monitor apparatuses are shown in FIG. 9A, the invention is not so limited, as any number of gateways and pallet monitor apparatuses may be used, taking into consideration the feasibility given the fiscal and management costs of equipment and network, compute and storage resources. Each of the pallet monitoring devices 923, 924, 926 and 928 may be implemented as the pallet monitoring device 200 or a variant thereof, and may be physically coupled to a pallet, for example as described elsewhere herein.

Each of the gateways 919-921 may be coupled to the cloud 901 and a plurality of pallet monitoring devices; for example, as the gateway 920 is coupled to the pallet monitoring devices 924, 926 and 928. Each gateway may couple one or more pallet monitoring devices to the cloud 901, which may include one or more servers. In some embodiments, one or more pallet monitoring devices, e.g., the pallet monitoring device 923, may be connected directly to the cloud. In such embodiments, the pallet monitoring device 923 may be configured with any of the gateway functionality and components described herein and treated like a gateway, at least in some respects, by the cloud 901.

Each of the gateways 919-921 may be configured with one or more capabilities of a gateway and/or a controller as described in U.S. Pat. No. 9,509,628, titled “Managing Devices in a Heterogeneous Network,” issued Nov. 29, 2016, to Bernd Moeller (hereinafter the '628 patent), including capabilities described in relation to FIGS. 1 and 2 (and elsewhere) of the '628 patent. Each of the gateways 919-921 may be any of a plurality of types of devices configured to perform the gateway functions defined herein, such as, for example, a general-purpose computer, a more specialized device such as an MYNXG® Edge/gateway or controller available from MyOmega (e.g., MYNXG® i2, d3 or Edge FCR 3), it shall be noted the terms MYNXG Transformation Layer/MYNXG Flow, MYNXG Service Layer/Core, MYNXG Gateway/ MYNXG Controller/MYNXG Edge and MYNXG Thing/MYNXG Sense are functional equivalent and any of variety of other devices, or any suitable combination of the foregoing.

Each gateway may include a TPM 917 (e.g., in a hardware layer of a controller described in the '628 patent), which may be used to perform any of a variety of data security operations, including encrypting portions of communications from/to pallet monitoring devices to/from gateways, or encrypting portions of such information received at a gateway unencrypted. TPMs also may be employed for other data security operations used in various embodiments of the system described herein, including generating a one-way hash (or another type of hash) of a transaction record, or providing secure communications between components of the system 900, e.g., between the cloud 901, gateways, pallet monitoring devices and/or end user devices.

For example, TPMs or other components of the system 900 may be configured to implement Transport Layer Security (TLS) for HTTPS communications and/or Datagram Transport Layer Security (DTLS) for Constrained Application Protocol (CoAP) communications, e.g., as described in the '628 patent. Furthermore, one or more security credentials associated with any of the foregoing data security operations may be stored on a TPM. The performance and security of the system described herein may be improved by pallet monitoring devices, user devices, gateways and servers in the cloud 901 using TPMs for these data security operations. A TPM may be implemented within any of the gateways, pallet monitoring devices or servers in the cloud 901, for example, during production, and may be used to personalize the gateway or the pallet monitoring device. Such gateways, pallet monitoring devices and/or servers may be configured (e.g., during manufacture or later) to implement a Public Key Infrastructure (PKI) for the management of keys and credentials. Other cryptographic technologies may be used.

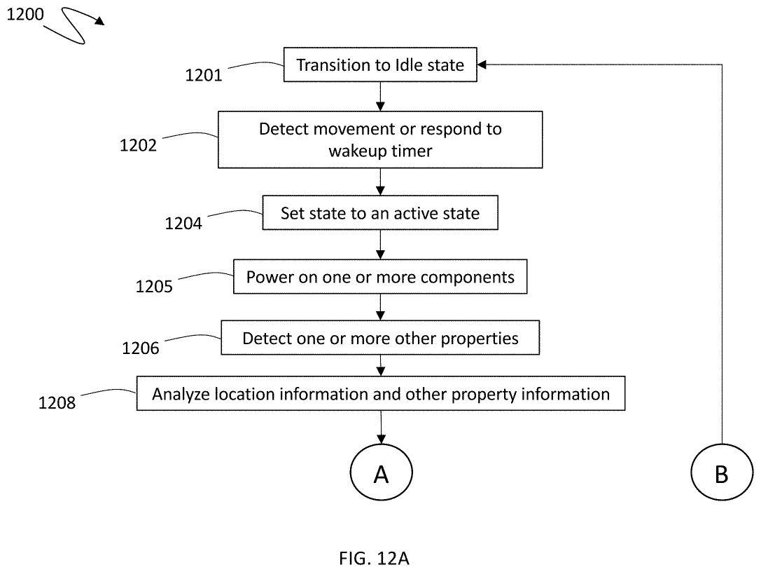

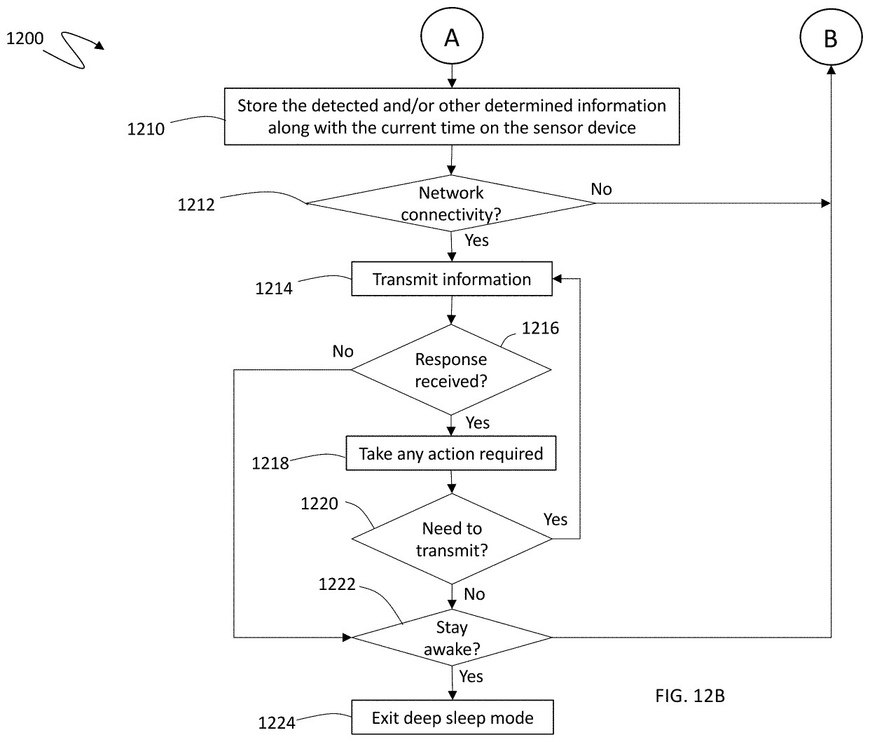

Each of the gateways 919-921 may be configured to process pallet status information received from a pallet monitoring device, including analyzing detected physical properties and other information that may have been generated or received by the pallet monitoring device, and providing instructions to the pallet monitoring device, as described in more detail in relation to FIGS. 11A and 11B and elsewhere herein. For example, each of the gateways 919-921 may be configured with one or more pallet management applications 922 encapsulating such capability. Further, each of the gateways 919-921 may include one or more edge pallet applications 932 that may provide additional functionality to that of the one or more pallet management applications 922, including for example, one or more functions pertaining to commissioning, loading, cleaning, incoming good inspections and certification (e.g., after 2 years), consumption of loads, unloading and other processing of pallets. It should be appreciated that certain pallet management functions may be shared between one or more pallet management applications 922 and edge pallet applications 932. Each of the gateways 919-921 may include one or more array components (which may be referred to herein as pallet management components) for implementing the one or more pallet management applications 922, the one or more edge pallet applications 932, or combinations thereof. The one or more pallet management applications 922 and/or edge pallet applications 932 may be configured to perform some or all of the analysis and/or control some or all of the actions described in relation to FIGS. 10-15 and elsewhere herein, in implementing one or more defined states of a pallet lifecycle. Each gateway may be configured to implement any of the network communication technologies described herein in relation to the pallet monitoring device 200 so that the gateway may remotely communicate with, monitor and manage pallet monitoring devices.

Each of the pallet monitoring devices 923, 924, 926 and 928 also may include one or more pallet management applications 933, 934, 936 and 938, respectively, having some or all of the same capability of pallet management application 922, and each of the pallet monitoring devices 923, 924, 926 and 928 may include one or more components (which may be referred to herein as pallet management components) for implementing the one or more pallet management applications 933, 934, 936 and 938, respectively. For example, the IPU 204 and/or one or more other components of the pallet monitoring device 200 may be configured to implement one or more pallet management applications, and may collectively, or each individually, be considered a pallet management component. By performing such processing at one or more gateways, and/or at the pallet monitoring devices themselves, as opposed to in a more centralized fashion on one or more servers in the cloud 901, the system 900 may implement and enjoy the benefits of more distributed edge-computing techniques.

The user devices 940, 942 may be any of a plurality of devices (e.g., desktop computers, laptop computers, tablets, personal digital assistants (PDAs), cellular smart phones or other devices) that enable a user to interact with other components (e.g., gateways, servers, pallet monitoring devices) of the system 900. Each user device may be configured with any of the functionality described in the '628 patent with respect to the UEs 54, 55, 56, including any user equipment functionality described in relation to FIGS. 2 and 3 of the '628 patent. In some embodiments, one or more gateways may be configured with user device functionality and/or one or more user devices may be configured with gateway functionality. It should be appreciated that, while two user devices 940, 942 are shown in FIG. 9, the invention is not so limited, as hundreds, thousands, tens of thousands or even more user devices may be included in the system 900.

The services layer/MYXNG Core 910 may provide one or more services, which may be consumed by applications in the transformation layer/MYNXG Flow (which also may be referred to as an application layer) 902. The services may include services for managing things, and the data and mobility of the things, for example, database management services for the transaction database 911, pallet database 912, pallet load database 914 and lifecycle management database 916. The pallet database 912 may include information about pallets managed by the system 900 such as, for example, mechanical specifications, geometries, date of creation, material composition and other information. The pallet load database 914 may include information about the load of a pallet being managed such as, for example, the type of item in the load (e.g., bags, kegs, barrels, KLTs), number of items in the load, the contents of the items, the ingredients, chemical composition, classification (e.g., pharmaceutical, beverage, food) of the items, properties of the load and other information collected over time, and other information about the load. Properties associated with a pallet may include physical properties associated with a pallet, such as, for example, climate conditions, location, weight, and pallet load properties (e.g., weight, number of loaded items), as well as other properties. Various other information, including properties, of a pallet, its load and its lifecycle may be stored in one or more of the databases 912, 914, 916 and 918, including, for example, an ATEX/NEC 500 /NEC 505 classification of a pallet's load or intended load, a maximum load of a pallet, other load properties and regulatory-related information. For a given pallet, the information stored in the pallet database 912 and/or the pallet load database 914 may include the same information as is stored in the pallet monitoring device itself, in which case the information concerning a given pallet in the databases may be considered a virtual representation of the pallet, e.g., a digital twin (copy). The lifecycle management database 916 may store information about the states, rules, algorithms, procedures, etc. that may be used to manage the pallet throughout the stages of its lifecycle, as described in more detail elsewhere herein.

The transaction database 911 may include one or more transaction records, for example transaction blocks of a blockchain, involving pallets managed by the system 900. For example, the blockchain may serve as a secure transaction register for the system 900 or one or more defined sub-systems thereof. Transactions may include smart contracts or any other commercial transaction involving one of the managed pallets, and also may include information, for example status information, relating to one or more pallets, that is not associated with a commercial transaction, as described in more detail elsewhere herein. Further, the data stored within each of the other databases 912, 914, 916 and 918 within the services layer 910 may be stored as one or more transaction records (e.g., transaction blocks within a blockchain), and may be part of the transaction register for the pallet management system 900 or one or more defined sub-systems thereof. Other databases 918 may be included in the services layer/core layer 910. The services layer/core layer 910 may be implemented using one or more servers in the cloud 901.

The transformation layer/MYNXG Flow 902 may include any of a variety of applications that utilize information and services related to pallet management, including any of the information and services made available from the services layer/core layer 910. The transformation layer/MYNXG Flow 902 may include any of: an inventory application 904, order a management application 906, one or more other applications 908, or any suitable combination of the foregoing. The inventory application 904 may provide an inventory of pallets managed within the system (e.g., the system 900 or a defined subsystem thereof), including properties (e.g., characteristics) about each pallet in the system, and the loads thereof, including the current state of the pallet within its lifecycle, a weight of a load on the pallet (“load weight”), number of loaded items (“item count”), current location (e.g., one or more network identifiers for a mobile telephony network, Wi-Fi network, ISM network or other) and any other properties corresponding to a pallet described herein. The inventory of pallets may be a group (e.g., “fleet”) of pallets owned, leased, controlled, managed, and/or used by an entity, for example, a pallet producer, OEM, transporter or consumer, another type of entity, or any suitable combination of the foregoing.

The order management application 906 may manage pallet orders of customers, for example, all customers of an entity, e.g., an OEM. The order management application 906 may maintain information about all past and current pallet orders for customers of an entity and process such orders. The order management application 906 may be configured to automatically order pallets for an entity (e.g., a customer or OEM) based on pallet status information received from pallet monitoring devices physically coupled to pallets (e.g., via one or more gateways or directly from the pallet monitoring device itself). For example, the application may have one or more predefined thresholds, e.g., of number of loaded pallets, number of damaged pallets, etc., after which being reached or surpassed, additional pallets should be ordered. The one or more other applications 908 may be any type of application, for-example, a value-add and/or business application, related to management of pallets. The inventory application 904, order management application 906 and one or more other application 908 may be configured (e.g., via one or more APIs or other interfaces) to interact with other applications within the transformation layer 902, including each other. These applications or portions thereof may be programmed into gateways and/or pallet monitoring devices of the pallet management network as well.

The transformation layer/MYNXG Flow 910 may be implemented using one or more servers. Pallet information may be communicated between components of the system 900, including pallet monitoring devices, gateways and components of the cloud 901, in any of a variety of ways. Such techniques may involve the transmission of pallet information in transaction records (e.g., blocks) of a blockchain or the like (e.g., using cryptographic techniques), and/or the storage of such records or information therein as part of blockchains or the like, for example, as part of a transaction register, as described in more detail elsewhere herein. Such transaction records may include public information and private information, where public information can be made more generally available to parties, and more sensitive information can be treated as private information made available more selectively, for example, only to certain pallet producers, OEMs and/or customers. For example, the information in the transaction record may include private data that may be encrypted using a private key specific to a pallet and/or pallet monitoring device, and may include public data that is not encrypted. The public data also may be encrypted to protect the value of this data and to enable the trading of the data, for example, as part of a smart contract. The distinction between public data and private data may be a matter of degree. For example, both public data and private data may be proprietary to a party, but the private data may be deemed more sensitive, e.g., more of a secret, and thus protected as such. For example, the public data may be basic specifications associated a pallet or a load thereof, which a party is willing to share with any customer or potential customer, whereas the private data is data the party may be data the party is only willing to share with a technology or business partner, for example, for a payment or license fee. Accordingly, public data may not be encrypted at all, enabling any party given access to the transaction record access to the public, or may be encrypted using a different credential (e.g., key) than the private data, so that a party can be more selective in enabling access to the private data; i.e., only give credentials associated with the private data to parties to certain contracts. Encrypted data, whether public or private, may be accessible only to those parties having a key corresponding to the private key, for example, the private key itself in a case in which symmetric cryptography is employed, or a corresponding asymetric key in a case in which asymmetric public key cryptography is employed. In this manner, parties owning information corresponding to a pallet, pallet monitoring device or other device may make some portions of the information public and other portions private to only select parties, for example, according to a smart contract, as described in more detail elsewhere herein.

Components of system 900 may be configured to reduce (e.g., minimize) the number of communications between components of the system 900, which in some embodiments may include communicating transactions (e.g., pallet status information) to servers within the cloud 901 according to a predefined schedule, in which gateways are allotted slots within a temporal cycle during which to transmit transactions (e.g., report pallet status information) to one or more servers. Each transaction transmitted from a gateway to a server may include pallet information received from one more pallet monitoring devices in one or more communications (e.g., status reports) sent from the pallet monitoring devices since a last such transaction was sent to the server, and may in some embodiments include only changes to information since a last transaction. Pallet information may be collected, stored and managed in a computationally efficient and secure manner that ensures to a high degree of certainty the integrity of the pallet.

It may be desirable to engage in commercial transactions involving pallets, for example, purchases, leases, licenses and other types of transactions, and blockchains may be used as part of contractual transaction between transacting parties. For example, the purchase or lease may include the seller providing the buyer access to and/or control of a transaction register of one or more pallets; e.g., in the form of a blockchain. Going forward from the time of the transaction, the buyer may continue to grow the blockchain, and at later date provide access to or control of the blockchain to a future buyer or other transacting party. In some embodiments, the contractual transaction itself is implemented using blockchains or the like. That is, a blockchain can be used to implement a “smart contract” between parties, for example, by defining the rules (i.e., terms) of the contract (including payment terms, access to information, timing, etc.), enforcing the rules of the contract, and recording the execution of the contract and/or transactions under the contract as transaction blocks of a blockchain. For example, a blockchain may define a license scheme (e.g., one-time fee, installment payments, pay-per-use, etc.) involving a fleet of pallets or subcomponents (e.g., parts) thereof as described herein, and record transactions under such a contract as transaction blocks of a blockchain. In some cases, the smart contract may define the rules for the exchange of information related to a fleet of pallets or parts thereof, or a subset thereof.

Such smart contracts may define rules governing the exchange of public and private data/information as described herein, and record the results of a transaction in relation to same. For example, a smart contract may define the rules by which a first party, e.g., a customer, is allowed access to public or private information of an OEM, e.g., the proprietary specification for a pallet, pallet monitoring device or combination thereof, in exchange for public or private information of the customer for pallet, pallet monitoring device or combination thereof, or perhaps in exchange for currency, e.g., bitcoins, or another asset. Proprietary information may include, for example, internal designs, proprietary interfaces, benchmarking results, other test data, manufacturing reliability data, customer lists, price lists, source code, etc. A smart contract may be defined to provide a party to the contract one or more keys (e.g., a private and/or public encryption keys) or other credential(s) that provides access to encrypted public or private information, for example, in response to a payment made by the party, performance of an action, or in exchange for some other form of consideration. The use of smart contracts may be applied to the management of pallet lifecycles as described herein and commercial transactions in relation thereto.

In some embodiments, information may be collected from one or more pallet monitoring devices (e.g., the pallet monitoring devices 924, 926, 928), for example, over a predetermined period of time, and may be grouped into a single secure transaction record. The secure transaction record may be sent from a gateway (e.g., one or more of gateways 919-921) to a server (e.g., residing within the cloud 901). The secure transaction maybe sent direct from a pallet monitoring device 923 to the cloud. Further, in embodiments in which a pallet monitoring device (e.g., the pallet monitoring device 923) communicates directly with one or more servers in the cloud, the pallet monitoring device itself may group information it has detected or determined over time about one or more pallets into a single secure transaction record that it transmits to the server. Each secure transaction record may include a one-way hash of, and a reference (e.g., link or pointer) to, an immediately preceding secure transaction record for the overall system (e.g., network) for which information is being tracked. A hash of a secure transaction record is the output of a mathematical function, algorithm or transformation (hereinafter “hash function”) applied to the secure transaction record. The hash function may be configured to produce a hash value that can be represented by a data structure (e.g., a string) of uniform size or range of sizes. In some embodiments of the system described herein, the hash is a one-way hash in that the hash function that produced the hash value is infeasible to invert (hereinafter a “cryptographic hash function”). By making the one-way hash part of the next (i.e., current) secure transaction record, it can be determined if an immediately preceding record has been altered because the one-way hash generated from the altered secure transaction record will not match what is stored in the next transaction in the chain. Furthermore, in embodiments of the system described herein, each secure transaction record includes a one-way hash of, and a reference (e.g., link or pointer) to an immediately preceding secure transaction record, forming a continuingly growing temporal list of records referred to herein as a record chain (e.g., a blockchain). Altering any secure transaction record in the record chain will have a cascading effect changing the expected one-way hash of every future secure transaction record, such that the source altered record can be determined. Thus, using a one-way hash function (or mathematical asymmetric hash function) enables, along with other features described herein, reliable tracking of pallet information in a system. Any of a variety of cryptographic one-way hash functions may be used, for example, MD4, MD5, SHA-1 and SHA-2.

In some embodiments, a record chain may be implemented using a blockchain, each secure transaction record of the record chain being implemented using a transaction block of the blockchain (also known as a block-chain or block chain). A blockchain is a continuously growing list of records, called blocks, which are linked and secured using cryptography. Each block contains transaction data or information, and may contain a hash pointer as a link to a previous block (i.e., an immediately preceding block in the chain), and a time stamp. By design, blockchains are inherently resistant to modification of the data. Blockchains may be considered an open, distributed ledger that can record transactions between two parties efficiently and in a verifiable and permanent way. For use as a distributed ledger, a blockchain may be managed by a peer-to-peer network collectively adhering to a protocol for validating new blocks. Once recorded, the data in any given block cannot be altered retroactively without the alteration of all subsequent blocks, which requires collusion of a network majority. Blockchains are considered secure by design and may be considered an example of a distributed computing system with high Byzantine fault tolerance. Although various embodiments of the system described herein use blockchains, the invention is not so limited. Other appropriate technologies may be employed to record transactions herein or to implement a record chain, where such technologies are inherently resistant to modification of the data and can record data in a verifiable and permanent way that preserves temporal relationships between the data blocks so that, for example, deletion/removal of any block(s) in the chain may be detected. Once the data is recorded in any block, such data cannot be altered retroactively without the alteration of all subsequent blocks in the block-chain.

FIG. 9B is a block diagram illustrating an example of using a secure transaction record 962, for example, a transaction block of a blockchain, to communicate and store pallet-related information on a pallet management network according to embodiments of the system described herein. Other secure transaction record formats, for example, variations of the secure transaction record 962, are possible and are intended to fall within the scope of the system described herein.

A plurality of pallet monitoring devices 982, 984, 986 may send (e.g., transmit) communications 988, 994, 995, respectively, to a gateway 960 (e.g., one of the gateways 919-921) concurrently or at different times, for example, in accordance with a predefined schedule, in response to an event (e.g., a determined change in property and/or state of a pallet) or in response to user input (e.g., a data request). Each of the communications 988, 994, 995 may include public information elements 990, 996, 997, respectively, and private information elements 992, 998, 999, respectively, described in more detail elsewhere herein. The gateway 960 may generate a secure transaction record 962 and may send the secure transaction record 962 to a server 956 (e.g., in the cloud 901). The secure transaction record 962 may include a transaction header 964 and a transaction body 966. The transaction body 966 may include public information elements 968, 972, 976 corresponding to the public information elements 990, 996, 997, respectively, and private information elements 970, 974, 978 corresponding to the private information elements 992, 998, 999, respectively.

The transaction header 962 may include a one-way hash 950 of an immediately preceding secure transaction record, tₙ₋₁, a reference (e.g., link or pointer) 955 to the immediately preceding secure transaction record, tₙ₋₁, a one-way hash 952 of a current secure transaction record, tₙ, and schedule information 954. The one-way hash of tₙ₋₁ may have been obtained from the server 956 in response to a request, or, in another embodiment, in an update from the server 956 in response to submission of another secure transaction record to the server 956. In some embodiments, information included in the record transaction body 966 may include only information corresponding to a pallet that has changed since a last transaction. In some embodiments, information unchanged since a last transaction is included in the transaction record body 966, and there is a mechanism for indicating which information has changed. The transmission of secure transaction records from gateways to a server (or directly from a pallet monitoring device such as the device 923 in FIG. 9A to a server) may be scheduled using predetermined time slots within a cycle. The transmission schedule may be defined, stored and/or under control of the server to which record transactions are transmitted, and may be implemented using any of a variety of technologies, including a cloud-based scheduler. The schedule information 954 may specify the predetermined time slot within a cycle for transmission of the secure transaction record 962 to one or more servers in the cloud 901.

The secure transaction records transmitted from gateways to servers (e.g., the secure transaction record 962) may be stored on the server as part of a transaction chain for the gateway, i.e., a transaction chain representing a pallet management system corresponding to the gateway. The server (e.g., the server 956) also may store the transaction record as part of a transaction chain corresponding to a pallet management system at the server/cloud level, for example, for which pallet management systems at the gateway level are subsystems. For example, one more servers in the cloud 901 may store a transaction chain that includes transaction records corresponding to gateways 919-921, as well as transaction chains corresponding to pallet monitoring devices (e.g., the pallet monitoring device 923) directly connected to one or more servers in the cloud 901. While FIG. 9B has been described primarily in relation to communicating information from pallet monitoring devices through gateways to servers in the cloud, it should be appreciated that the invention is not so limited. In some embodiments of the system described herein, a pallet monitoring device (e.g., the pallet monitoring device 923) may collect pallet information over time and transmit a secure transaction record like that described herein directly to one or more servers in the cloud without use of a gateway.

FIG. 10 is a state diagram illustrating an example of a plurality of defined states of a pallet lifecycle, according to embodiments of the system described herein. Other embodiments of states, for example, variations the states depicted in FIG. 10, are possible and are intended to fall within the scope of the invention. For example, the same or similar states may be defined and used for other types of things besides pallets. The states may include any of: an idle state 1001; a pallet production state 1002; a preparation state 1004; a pallet loading state 1006; a transport-to-customer state 1008; a monitor-at-customer state 1010; a transport-back-to-OEM state 1012; an EOL state 1014; a transport-to-production state 1016; other states; or any suitable combination of the foregoing. Each state other than the idle state 1001 may be referred to herein as an active state, and collectively such states may be referred to as active states. Each arrowed line between states in FIG. 10 illustrates a potential state transitions, with the direction of the arrow indicating the direction of the transition. It should be appreciated that more states or less states may be defined for the lifecycle of a pallet or defined but not used. In some embodiments, it may be desirable to maintain a smaller number of states to reduce an amount of resources (e.g., compute, networking and/or storage resources) consumed in managing the lifecycle of a pallet or a group of pallets. For example, in some embodiments, one or more of the states involving the pallet producer (1002 and 1016) and the EOL state 1014 may not be defined or used, such that only the states 1001, 1004, 1006, 1008, 1010 and 1012 are defined and used.

In the idle state 1001, a pallet may be idle, for example, during a deep sleep mode, in which power consumption may be reduced (e.g., minimized). In some embodiments, the idle state 1001 may be transitioned to/from any of the active states, as described in more detail elsewhere herein. The term “deep sleep mode” may be used herein to refer to a cyclical mode of operation of a pallet monitoring device during which the pallet monitoring device iteratively transitions between the idle state 1001 and one of the active states, during which the pallet monitoring device is in the active state for only a fraction of a percentage of time relative to time spent in the idle state 1001, and sensor status information is reported to a pallet management network during the active state if possible. In some embodiments, deep sleep mode may be implemented by mechanisms described elsewhere herein.

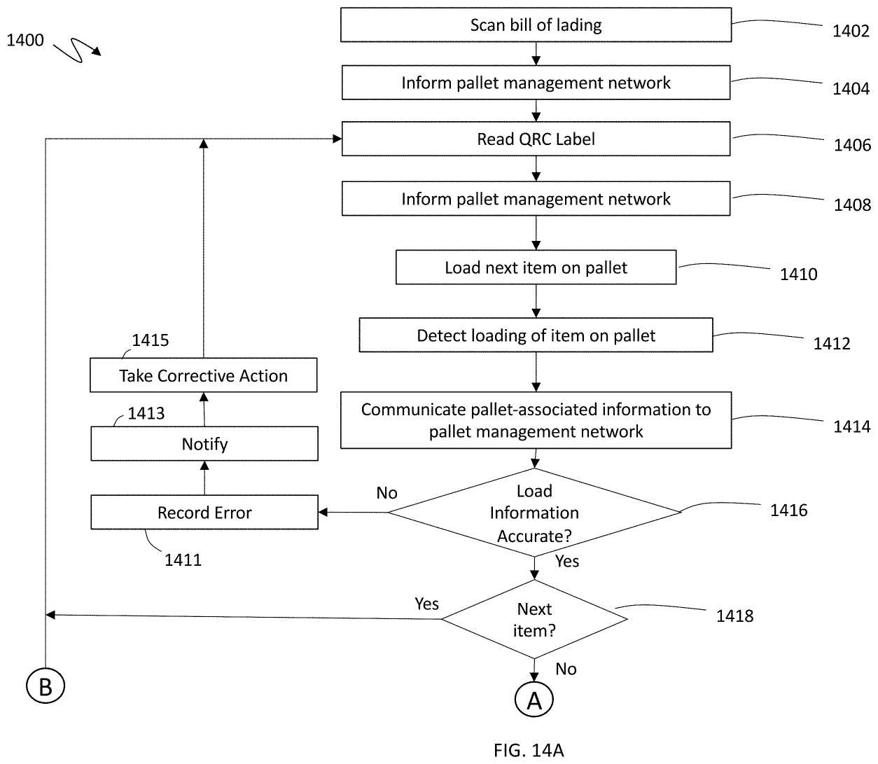

The pallet monitoring device may be configured to transition from an active state to the idle state 1001 in response to a variety of conditions, for example, any of: an instruction (e.g., received from pallet management network); determining a passage of a predetermined amount of time without any activity (e.g., no change in any properties); determining a passage of a predetermined amount of time without a change to one or more particular properties; and/or determining a predefined time of day (e.g., after hours of operation) and/or day of the week (e.g., weekend), month or year (e.g., holiday). The conditions under which each state may transition to the idle state 1001 may be different, as described in more detail elsewhere herein. In some embodiments of the system described herein, a transition to the idle state 1001 may be conducted in accordance with the method 1300 described in relation to FIG. 13.

In the pallet production state 1002, a pallet producer produces (e.g., manufactures) a pallet or prepares a used pallet. During this state, a physical coupling of the pallet monitoring device (e.g., the pallet monitoring device 200) to the pallet may be performed, for example, resulting in the pallet monitoring device being physically coupled, as described elsewhere herein. The pallet production state 1002 may transition to the idle state 1001 or the preparation state 1004.

In the preparation state 1004, an OEM prepares a pallet, which may include repairing, cleaning and/or testing of the pallet. The preparation state 1004 may transition to the idle state 1001 or the pallet loading state 1006. In the pallet loading state 1006, the OEM loads the pallet with load items, for example, kegs, barrels, KLTs or bags. The pallet loading state 1006 may transition to the idle state 1001 or the transport-to-customer state 1008. In the transport-to-customer state 1008, the pallet is transported from the OEM to customer premises (or perhaps other premises on behalf of the customer). The transport-to-customer state 1008 may transition to the idle state 1001 or the monitor-at-customer state 1010.

In the monitor-at-customer state 1010, the load of the pallet is consumed by the customer, for example, in one or more iterations. The monitor-at-customer state 1010 may transition to any of the states 1001, 1012, 1014 or 1016. In the transport-back-to-OEM state 1012, the pallet is being returned to the OEM. The transport-back-to-OEM state 1012 may transition to the idle state 1001 or the pallet production state 1002. In the EOL state 1014, as an alternative to transition from monitor-at-customer state 1010, the pallet is in an end-of-life (EOL) state, as a result of having been discarded by the customer. In the transport-to-production state 1016, as an alternative to being in the state 1012 or the state 1014, the pallet is in a state of being transported back to the pallet producer. The transport-to-production state 1016 may transition to the idle state 1001 or the pallet production state 1002. The conditions under which states transition to other states are described in more detail elsewhere herein

During the preparation state 1002, a pallet battery/accumulator may be loaded. The pallet does not contain any LEDs, hence the information from the lifecycle management database 916 or from the inventory application 904 may be used and the user devices (940/942) may be used to scan the pallet and to identify, via QRC and/or other labels at the pallet, the identity of the pallet. This information may be exchanged with the pallet management system 900 to identify the need to charge the battery/accumulator inside the pallet via wireless inductive charging.

During the preparation state 1002, a pallet may be cleaned and the temperature of the pallet, as well as other properties and information, may be monitored and controlled. For example, the duration of a cleaning may be recorded along with the temperature within a housing of a pallet monitoring device coupled to the pallet from which a temperature of steam or other cleaning agent or substance resulting from cleaning may be estimated. Based on such recorded duration and temperature, cleaning quality information may be documented. In some embodiments, the pallet monitoring device may be configured to provide a notice and/or alarm if a temperature reaches a certain threshold, or even stop a cleaning process if coupled to an automated system performing the cleaning. Different notices and/or alarms may be configured for different thresholds. Such thresholds may be determined and configured to protect the pallet, the pallet monitoring device or components thereof, for example, to prevent a battery within or physically connected to the pallet monitoring device from exploding and thus damaging other components of the pallet monitoring device.

It may be desirable when preparing a pallet to conduct one or more quality inspections of the pallet. Accordingly, the pallet monitoring device may be configured during the preparation state 1002 to control and/or assist in conducting a quality inspection. For example, the pallet monitoring device may include one more components (e.g., described elsewhere herein) to assist in conducting high-frequency sampling and analysis of resonant frequencies of the pallet to determine whether the pallet satisfies certain physical requirements and/or has been damaged (e.g., by comparison to predefined parameter values and/or previous measurements). Such sampling and analysis may be done via integrated acceleration/microphone measurements in response to an inspector performing a smooth hammering on the pallet. While the pallet monitoring device may be configured to process and analyze the data sampled by its one or more sensors, one or more gateways, servers, or other elements of a pallet management network (e.g., the system 900) may be involved in performing analysis of the sampled data, for example, mathematical analysis such as Fast Fourier Transform (FFT) analysis. Inspecting the physical quality of, including detecting damages to, the pallet using resonant frequency analysis may be preferred over employing an x-ray device to perform x-ray analysis (e.g., to detect capillary cracks), as such an x-ray device and/or use thereof may be relatively expensive. Other aspects of the pallet may be monitored, and/or other actions controlled during the preparation state 1004.

The pallet monitoring device may be configured to transition from the preparation state 1004 to the idle state 1001 in response to: an instruction (e.g., from pallet management network); in response to determination of passage of a predetermined amount of time without any activity (e.g., no change in any physical properties); and/or determination of a predefined time of day (e.g., after hours of operation) and/or day of the week (e.g., weekend), month or year (e.g., holiday). The transition from the preparation state 1004 to the idle state 1001 may be performed in accordance with mechanisms described elsewhere herein.

The pallet monitoring device may be configured to transition from the preparation state 1004 to the pallet loading state 1006 under one or more conditions. In some embodiments, such a state transition may occur in response to determining that the pallet monitoring device (and by inference the pallet) has changed location to a loading location. The location change may be determined using one or more of the networking technologies described elsewhere herein. For example, the pallet monitoring device may be configured to determine a transition from the preparation state 1004 to the pallet loading state 1006 based on determining a move to a loading location based on one or more detected: cellular network cells (e.g., based on cellular IDs), Wi-Fi networks, GPS location or ISM location. In some embodiments, the pallet monitoring device may be pre-programmed with the cellular ID, Wi-Fi network ID, ISM location and/or GPS location of one or more loading locations, and the IPU of the pallet monitoring device may determine when one of these parameter values has been sensed by the associated interface or other logic. Given the possible geographic proximity (e.g., same building and/or room) of the location at which the pallet is prepared with the loading location, it may be desirable to use a network location technology that provides relatively precise location information to determine such a transition, for example, ISM or GPS technology, or UWB Real Time Localization Services, rather than cellular or Wi-Fi technology. In determining the location technology or technologies with which to configure the pallet monitoring device to determine location movement, the cost of using the technology may be taken into consideration in addition to the precision of the location technology. Such consideration may be made for any transition between defined states of a pallet lifecycle involving detection of location movement.

The pallet monitoring device also may be configured to transition from the preparation state 1004 to the pallet loading state 1006 in response to receiving instructions, for example, from a user via a gateway, user device and/or other component of a pallet management network. During the pallet loading state 1006, if not already recorded, a network ID (e.g., cellular ID or Wi-Fi ID) or other indication of location may be recorded, which then can be used to determine a location change that may signify a transport of the pallet. With respect to cellular networks, the IDs of neighboring cells may be recorded as well.

A pallet monitoring device may be configured to store, for example, during the pallet loading state 1006, a product identifier of the pallet, an identifier of the pallet monitoring device itself, information about the item(s) with which the pallet is being loaded, product specifications of any of the foregoing, an address or other location ID of an intended customer, other information, or any suitable combination of the foregoing. Such information may be stored in a non-volatile memory of the pallet monitoring device, and portions of such information may be obtained via the network interfaces for one or more networks described herein, including the pallet management network 900. During the pallet loading state, the load weight and item count of the pallet may be monitored and recorded, and in some embodiments controlled (e.g., if an automated loading device is coupled to the pallet monitoring device), by the pallet monitoring device. Other measurements may be made during the pallet loading state 1006 by the pallet monitoring device.

The pallet monitoring device may be configured to transition from the pallet loading state 1006 to the idle state 1001 in response to: an instruction (e.g., from the pallet management network); in response to determination of passage of a predetermined amount of time without any activity (e.g., no change in any physical properties); and/or determination of a predefined time of day (e.g., after hours of operation) and/or day of the week (e.g., weekend), month or year (e.g., holiday).

The pallet monitoring device may be configured to transition from the pallet loading state 1006 to the transport-to-customer state 1008 under one or more conditions. In some embodiments, such a state transition may occur in response to determining that the pallet monitoring device (and by inference the pallet) has changed location (i.e., moved away) from a pallet loading site. The change in location may be determined using one or more of the networking technologies described elsewhere herein, for example, by detecting a transition between one or more cellular network cells, a movement within a cell, a change in GPS location or a transition between one or more Wi-Fi networks. For example, the pallet monitoring device may have recorded the cellular ID, Wi-Fi network ID, ISM location and/or GPS location of the loading location (and the cellular IDs of neighboring cells at this location) as values for corresponding parameters, and the IPU of the pallet monitoring device may determine when a determined value of one of these parameters for a current location no longer matches that of the loading station. For example, even if the cellular ID of the current cell has not changed, if the cellular IDs of the neighboring cells have changed, this may signify a change in location of the pallet. Further, the strength of cellular signals may be recorded during various lifecycle states of the pallet (e.g., the pallet loading state 1006), and the difference in strength measured at different times may signify a change in location, which may or not be interpreted to mean a change in state (e.g., a change from pallet loading state 1006 to transport-to-customer state 1008). The pallet monitoring device may be configured to determine (using one or more of the technologies above) whether a change in location should result in a change of state. For example, the pallet monitoring device may be configured to determine whether a change in location indicates a departure from an OEM, customer or pallet producer premises, may be configured to distinguish between a temporary departure (e.g., between proximate sites of a customer site) and a permanent departure (e.g., a return from a customer site to an OEM site).

The pallet monitoring device may be configured to be in a deep sleep mode during transport to a customer. That is, as described elsewhere herein, the pallet monitoring device may enter into a cyclical mode of operation during which the pallet monitoring device iteratively transitions between the idle state 1001 and the transport-to-customer state 1008. During each iteration of the deep sleep mode, the pallet monitoring device may remain in the transport-to-customer state 1008 for only a very small percentage of time relative to time spent in the idle state 1001 during which sensor status information is reported to a pallet management network (e.g., the system 900) if possible. During the transport to the customer, the pallet monitoring device may initially transition from the transport-to-customer state 1008 to the idle state 1001 in response to, for example: an instruction (e.g., from the pallet management network); in response to determination of passage of a predetermined amount of time without any activity (e.g., no change in any physical properties); or passage of a predetermined amount of time since the initial transition from the pallet loading state 1006 to the transport-to-customer state 1008.

During the transport-to-customer state 1008, information detected from the integrated ambient light sensor 214, and possibly information detected from one or more other sensors, may be detected and analyzed to determine whether there has been any damage or other degradation of quality to the pallet, pallet load thereof or even the pallet monitoring device itself. For example, while being transported to the customer, the pallet monitoring device may be woken up from the idle state 1001 into the transport-to-customer state 1008 in response to movement detected by the movement sensor 216. The extent of the detected movement; i.e., of the acceleration and/or displacement, may vary from being very minor (e.g., from a small crack or bump in the road or too sharp of a turn) to being a severe shock (e.g., from a major pothole or an accident). The information detected and analyzed from the various sensors in response to the pallet monitoring device being woken up can help make this determination.

Other information detected from various sensors at different times (e.g., each time the pallet monitoring device is woken up) during the transport-to-customer state 1008, for example, air temperature, humidity and pressure, may be used to assess a dynamic impact on the load of the pallet over time. For example, in the case of the load being food, beverage, lacquer, chemicals or medication, or other suitable materials, such assessment may be used to estimate “best-if-used-by” or “best before” dates, expiration dates and the like. This same analysis may be performed while the pallet is in other states as well, for example, the pallet loading state 1006 and the monitor-at-customer state 1010.

The pallet monitoring device may be configured to transition from the transport-to-customer state 1008 to the monitor-at-customer state 1010 under one or more conditions including, for example, conditions determined from detected properties and information received from the pallet management network. In some embodiments, such a state transition may occur in response to determining that the pallet monitoring device (and by inference the pallet) has arrived at a site of a customer, which may be determined using one or more of the networking technologies described elsewhere herein. For example, the pallet monitoring device may be configured with the cellular ID, Wi-Fi network ID, ISM location and/or GPS location of one or more customer sites, and the IPU (or other component) of the pallet monitoring device may determine when a detected value of one of these parameters for a current location matches that of one of the customer sites.

While in the monitor-at-customer state 1010, the load of the pallet may be consumed; i.e., unloaded all at once or in many iterations over time. An all-at-once unloading and each iteration of a more gradual unloading may be referred to herein as an “unloading event.” During the monitor-at-customer state 1010, the pallet monitoring device also may be configured to determine an unloading event when it is senses (e.g., via RFID reader or optical code reader) that one or more load items has been removed from the pallet and/or the weight of the load has decreased (e.g., by a reduced amount of detected force acting towards the ground). The pallet monitoring device may be configured to record the number of unloading events that occur while the pallet is at a customer site (e.g., while in the monitor-at-customer state 1010), as this may be desirable for some industries, for example, the hygienic requirements of the food or beverage industry in various jurisdictions. The pallet monitoring device also may be configured to measure, record and report the load weight and item count, and optionally one or more other properties associated with the pallet and/or load thereof, as described elsewhere herein, for each unloading event. The number of unloading events, and the load weight, item count and one or more other properties detected before, during and/or following each unloading event may be used to estimate an extent to which a pallet has been contaminated (i.e., polluted) over time. This estimate may prove important during a next preparation state 1004, for example, in determining the cleaning effort that will be required.

During the monitor-at-customer state 1010, the pallet monitoring device also may be configured to determine, e.g., using information detected by the movement sensor 216, the integrated ambient light sensor 214, and perhaps other sensors, fraud conditions, accidents and or movements of the pallet, as described elsewhere herein. Also, while at the customer site, it may be desirable to mix ingredients within the pallet, and the pallet monitoring device may be configured in the monitor-at-customer state 1010 to monitor, report on and/or control the mixing.

The pallet monitoring device may be configured to transition from the monitor-at-customer state 1010 to the transport-back-to-OEM state 1012 under one or more conditions. In some embodiments, such a state transition may occur in response to determining that the pallet monitoring device (and by inference the pallet) has changed location (i.e., moved away) from the customer site. The change in location may be determined using one or more of the networking technologies described elsewhere herein, using techniques described herein. For example, the pallet monitoring device may have recorded the cellular ID, Wi-Fi network ID, ISM location and/or GPS location of the customer location (and the cellular IDs of neighboring cells at this location) as values for corresponding parameters, and the IPU of the pallet monitoring device may determine when a determined value of one of these parameters for a current location no longer matches that of the customer location, using techniques like those described above. The pallet monitoring device may be configured to determine whether a change in location indicates a departure from the customer premises and/or whether such departure is temporarily or permanent (in the context of a single cycle of a pallet lifecycle).

In embodiments in which the EOL state 1014 and/or the transport-to-production state 1016 state are defined and used, the pallet monitoring device may be configured to transition from the monitor-at-customer state 1010 to the EOL state 1014 and/or transport-to-production state 1016, respectively, using the same, similar and/or analogous techniques as described herein for transitions between other defined states.

The pallet monitoring device may be configured to be in a deep sleep mode during transport back to an OEM from a customer. That is, as described above, the pallet monitoring device may enter into a cyclical mode of operation during which the pallet monitoring device iteratively transitions between the idle state 1001 and the transport-back-to-OEM state 1012. Any of the actions described above in relation to the transport-to-customer state 1008 (except possibly transitioning to the monitor-at-customer state) may be performed during the transport-back-to-OEM state 1012. The pallet monitoring device may be configured to transition from the transport-back-to-OEM state 1012 to the preparation state 1004 under one or more conditions, for example, information received from the pallet management network. In some embodiments, such a state transition may occur in response to determining that the pallet monitoring device (and by inference the pallet) has arrived at a site of an OEM, which may be determined using one or more of the networking technologies described elsewhere herein. For example, the pallet monitoring device may be configured with the cellular ID, Wi-Fi network ID, ISM location and/or GPS location of one or more sites of an OEM, and the IPU (or other component) of the pallet monitoring device may determine when a detected value of one of these parameters for a current location matches that of one of the OEM sites.

In embodiments in which the transport-to-production state 1016 state and the pallet production state 1002 are defined and used, the pallet monitoring device may be configured to transition from the transport-to-production state 1016 to the pallet production state 1002 using the same, similar and/or analogous techniques as described herein for transitions between other defined states.

FIGS. 11A and 11B collectively are a flowchart illustrating an example of a method 1100 of managing a lifecycle of a pallet, according to embodiments of the system described herein. Other embodiments of a method of managing a lifecycle of a pallet, for example, variations of the method 1100, are possible and are intended to fall within the scope of the invention. The method 1100 may be implemented for a pallet having a pallet monitoring device (e.g., the pallet monitoring device 200) physically coupled thereto, and for which a plurality of states (e.g., those described elsewhere herein) are defined. The method 1100 may include consideration of a current state of a pallet and one or more properties detected from one or more sensors (e.g., any of those described in herein) of the pallet monitoring device and/or determined from information detected from the one or more sensors. While the load weight and item count of a pallet may be of primary importance for a particular state (e.g., the pallet-loading state 1006 or the monitor-at-customer state 1010), other properties (e.g., temperature, air pressure, air humidity) detected from other sensors and analyzed along with one of more determinations of load weight and/or item count may better inform a current status of a pallet and/or a decision about an action to be taken, which may depend on the current state.

In a step 1101, the states of a pallet lifecycle may be defined, which may include any of the states described herein. These states may be stored on a plurality of components of a pallet management system, for example, on the pallet monitoring devices, gateways, user devices, one or more servers and/or possibly other components of the system 900 described elsewhere herein.

In a step 1102, the pallet monitoring device may be initialized, which may include defining an initial state for the pallet, for example, the idle state 1001 or the preparation state 1004. Initializing the pallet monitoring device also may include configuring the pallet monitoring device by loading software (e.g., including firmware) and software parameters onto the pallet monitoring device, including software and/or parameters for specific components of the pallet monitoring device, for example, components of the IPU. The initial state of the pallet may be configured for the pallet monitoring device as part of loading the software. The software and software parameters may define one or more aspects of the functionality of the pallet monitoring device and/or components thereof described herein. For example, one or more algorithms may be specified by such software. An algorithm may be: generic to all defined states of the lifecycle of the pallet; specific to one or more defined states; or even specific to certain modes or events within a certain predefined state. The functionality (i.e., behavior) of the pallet monitoring device, for example, as embodied by one or more algorithms stored thereon, may be defined to be specific to particular use(s), industry(s) or load (s) that will be carried by the pallet (e.g., kegs, drums, bags, KLTs, and/or the contents of any of the foregoing) and the expected lifecycle of the pallet given the intended use (e.g., commercial process) involving the loads.

In a step 1103, it may be determined whether deep sleep mode should be entered. On a first pass through the method 1100, this determination may involve simply determining whether the current state is set to the idle state 1001, meaning that it was intended that the pallet monitoring device start in deep sleep mode. In future passes through method 1100, determining whether to enter into deep sleep mode may include one or more of the following: following an instruction (e.g., received from pallet management network); determining a passage of a predetermined amount of time without any activity (e.g., no change to any physical properties); determining a passage of a predetermined amount of time without a change to one or more particular properties; and/or determining a predefined time of day (e.g., after hours of operation) and/or day of the week (e.g., weekend), month or year (e.g., holiday). The step 1103 also may include factoring in the current defined state of the pallet, as different states may produce different results for the same or similar determined properties or other conditions. While the step 1103 is illustrated in FIG. 11A as being performed at a particular point in a series of steps of the method 1100, it should be appreciated that the step 1103, and the potential result of transitioning to deep sleep mode, may be performed at different times during the performance of the method 1100 after the pallet monitoring device is initialized in the step 1102. For example, determining whether to enter deep sleep mode may be performed as part of the step 1106, and the step 1107 may include transitioning to the step 1104 to execute deep sleep mode.

If it is determined in the step 1103 to enter deep sleep mode, then the method 1100 may proceed to a step 1104, in which deep sleep mode may be executed. The method 1100 may return from deep sleep mode for one or more reasons described elsewhere herein and proceed to a step 1105, or may proceed to the step 1105 directly from the step 1103 if it is determined not to enter sleep mode.

In the step 1105, one or more properties associated with the pallet may be detected. Such properties may include one or more properties detected by any of the sensors described herein, including an RFID (NFC) reader or an RFID (UHF) reader, optical code reader, strain gauge, climate sensors or sensors of other physical properties. The step 1105 may be performed: at specific predefined times, for example, at predefined intervals; at one or more specific times of a day; and/or specific days of a week, month or year. For example, the pallet monitoring device may be configured to detect sensor input at a predefined rate (e.g., a sampling rate), e.g., once every x hour(s), once every x minute(s), once every x second(s), less than a second, etc., and the sampling rate may be different for different times of day, or days of a week, month or year. One or more properties may be detected in response to an event, for example, user input, a signal transmitted from a sensor and/or a change in information transmitted from a sensor.

In a step 1106, the pallet monitoring device may analyze the detected properties, which may produce other information and/or result in action being taken. Such analysis may be based at least in part of the defined state of the pallet. This analysis may be performed by one or more components of the pallet monitoring device for example, the IPU 204 of the pallet monitoring device 200 or components thereof. Such analysis may involve performance of one or more algorithms using one or more values of parameters that may have been initially programmed onto the pallet monitoring device, and perhaps later updated with information received from the pallet management network. The step 1106 may include taking into consideration other conditions, including, for example, the time of day, day of week, month or year, updated software or parameter values received from the pallet management network, user input, other conditions, or a suitable combination thereof. The analysis performed in the step 1106 may include any of the analysis described herein, including but not limited to: determining a change in location; determining whether damage has occurred to the pallet and/or pallet monitoring device; during the preparation state 1004, determining the occurrence and the quality of cleaning performed on a pallet and/or conducting quality testing on the pallet; during the pallet loading state 1006, detecting whether and when a loading event has occurred; during the monitor-at-customer state 1010, determining whether and when an unloading event has occurred.

Performance of the step 1106 may result in a determination that the defined state of a pallet should be changed, e.g., as described in relation to any of the defined states described elsewhere herein, and this change of state may be one of the actions taken in a step 1107. Other actions may include, for example: powering down, powering up or adjusting behavior of a sensor, component of a pallet monitoring device or device coupled thereto; controlling an action to be taken on the pallet (e.g., cleaning, loading, unloading, movement, etc.), e.g., by controlling one or more automated devices coupled to the pallet monitoring device; activating an alarm (e.g., a visual, sound or noise); other actions; or any suitable combination of the foregoing. It should be appreciated that different actions may be taken for the same determined property for different defined states and/or other conditions such as, for example: the time of day, day of week, month of year; updated software or parameter values received from the pallet management network; user input; other conditions; or a suitable combination thereof.

In the step 1107, any actions determined in the step 1106, including changing the defined state, may be taken based on the analysis of the one or more detected properties, which may be based at least in part on the current defined state.

In a step 1108, status information may be stored on the pallet monitoring device, for example, in non-volatile memory of the pallet monitoring device. The status information can be any current status information about the pallet, including current location (e.g., one or more network identifiers for a mobile telephony network, Wi-Fi network, ISM network or other), any other property detected or other information generated by analysis performed on the detected properties.

In a step 1110, the status information may be transmitted to the pallet management network (e.g., a gateway of the network) if possible; i.e., if a communication path can be established with the pallet management network. The step 1110 may be performed at specific predefined times, for example, at predefined intervals (e.g., every x seconds, minutes, hours or days, etc.), at one or more specific times of a day, and/or specific days of a week, month or year, in response to a request or other information received from the pallet management network, e.g., a gateway of the system 900, or in response to an event, e.g., an interrupt caused by the movement sensor 216 or another component of the sensor or a component external thereto. In some cases, a network may be down or the pallet monitoring device may be out-of-range of a network (e.g., not within range of a Wi-Fi access point, not within range of a cell tower, obstructed from a satellite feed, etc.), in which case the status information will not be transmitted until a later time at which a communication path can be established. In some embodiments, in the event status information cannot be transmitted when desired, the pallet monitoring device may be configured to try again at a predetermined amount of time after the current failed attempt, for example, at a time different than (e.g., before) a next attempt would regularly be scheduled. In some embodiments, only information that has changed since a last communication of status information to the pallet management network may be transmitted in the step 1110. In some embodiments, the status information may be transmitted as a transaction record, for example as a blockchain transaction.

In response to the pallet monitoring device transmitting the status information to the pallet management network, in the step 1111 information may be received from the network. Such received information may include updates or other changes to the software (e.g., including firmware) and/or software parameters that define functionality and behavior of the pallet monitoring device, including software and/or parameters for specific components of the pallet monitoring device, for example, components of the IPU 204. Such information also may include instructions for actions to be taken by the pallet monitoring device. In some embodiments, information may be received from the pallet management network independent of any status information being transmitted to the network from the pallet monitoring device, for example, at any time during the performance of the method 1100 after the pallet monitoring device is initialized in the step 1102, and in some cases initializing the pallet monitoring device in the step 1102 may include using information received from the pallet management network. Receiving information from the pallet management network enables any of a variety of adaptations to be made to the pallet monitoring device during its lifecycle, for example, per the desire of an OEM or a customer, which can improve or otherwise adapt services over time.

In some embodiments of the system described herein, software and/or software parameters transmitted to the sensor service may be digitally signed by an authorized entity of the pallet management network. In such embodiments, the steps 1112, 1113 may include determining whether the information received from the pallet management network includes any updated software and/or software parameters, and if so, whether the updated software and/or software parameters are authentic. Determining whether the updated software and/or software parameters are authentic may include verifying the digital signature with which the software and/or software parameters are signed, for example, by certification of a digital certificate of the digital signature, e.g., with a certifying authority, and/or by employing symmetric (e.g., shared secret) and/or asymmetric (e.g., public/private keys) cryptographic techniques on the digital signature. If it is determined that the updated software and/or parameters are authentic, then, in a step 1115, the pallet monitoring device may be updated with the updated software and/or parameters and the software may be locked—i.e., secured so that it cannot be modified or otherwise tampered with by an unauthorized individual or other entity. In a step 1117, the pallet monitoring device may be updated with other information (i.e., other than software or software parameters) communicated from the pallet monitoring device. If the received information does not include updated software and/or parameters or if such updated software and/or parameters is determined to not be authentic, then the method 1100 may proceed to the step 1117.

In some embodiments of the system described herein, any information received in the step 1111 from the pallet management is digitally signed, not just updated software and/or updated software parameters, such that the received information must be proven authentic before being applied to the pallet monitoring device. Any of the authentication steps and/or the locking of the software may be performed using a TPM or another secure cryptographic component included in the pallet monitoring device, for example, the TPM 212 of the pallet monitoring device 200.

It should be appreciated that the step 1117 may be performed before or concurrently at least in part with any of the steps 1112-1115. Further, while the steps 1106 and 1107 are depicted as discrete steps performed in series as part of a series of steps of the method 1100 in FIG. 11A, it should be appreciated that such depiction is for illustrative purposes, and the invention is not so limited. The steps 1106 and 1107 may be performed at different times during performance of the method 1100, for example, after or concurrently with the steps 1108-1117. In some embodiments, the steps 1106 and 1107, or portions thereof, may be performed prior to the steps 1110 and/or 1111 as illustrated, and again after receiving information from the pallet management network in a step 1111 and/or after performance of step 1112-1117. When analyzing detected properties and taking determined action, if any, after information is received from the pallet management network, the analysis and/or action may take into account the information received. For example, components within a pallet management network, for example, one or more servers, gateways, pallet monitoring devices or other devices, may perform part or all of the analysis described in the step 1106, and provide in the information received in the step 1111 instructions of actions to be taken by the pallet monitoring device, or other information that will result in the pallet monitoring device changing behavior, for example, a changed parameter value or software. It should be appreciated that analysis may be shared between the pallet monitoring device, gateway, servers or other components of the pallet management network. For example, a gateway may determine that the defined state should be changed from one state to another state based on information transmitted from the pallet monitoring device in the step 1110. The pallet monitoring device may be configured to perform some analysis based on the properties detected in the step 1105, and transmit the status information to the gateway in the step 1110, and to execute one or more steps specific to the changed state in response to information indicating the changed state received from the gateway in the step 1111.

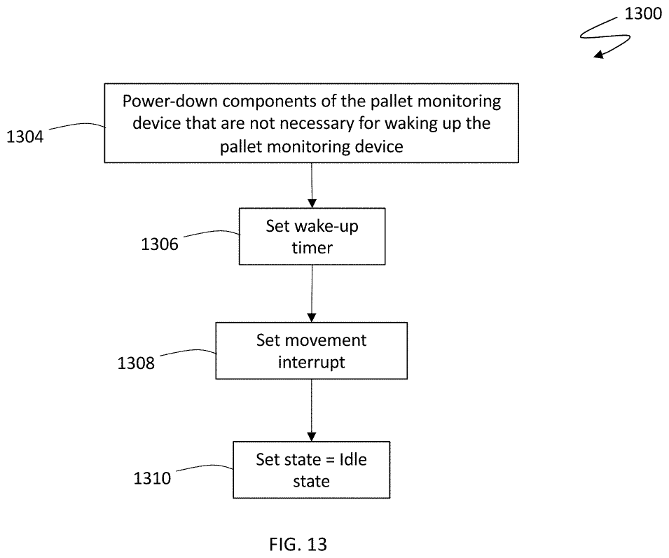

FIGS. 12A and 12B collectively are a flowchart illustrating an example of a method 1200 of implementing a deep sleep mode of operation for a pallet monitoring device, according to embodiments of the system described herein. Other embodiments of a method of implementing a deep sleep mode of operation for a pallet monitoring device, for example, variations the method 1200, are possible and are intended to fall within the scope of the invention. In a step 1201, the state of a pallet monitoring device may transition to the idle state 1001. This transition to the idle state 1001 may be from any of the active states described elsewhere herein, for example in response to conditions described elsewhere herein. In some embodiments, the idle state 1001 may be the default state with which a pallet monitoring device is initialized.

In a step 1202, movement may be detected (e.g., by the movement sensor 216) or wake-up signal may be received (e.g., from the timer component 213) at a predetermined time and/or interval. For example, as described elsewhere herein, the timer component 213 of the pallet monitoring device may set a wake-up timer for one hour, several hours, once a day, less than one hour or other elapsed times from a time immediately following the powering down of components of the pallet monitoring device that are not necessary for waking up the pallet monitoring device. In some embodiments, it may be desirable to set the amount of elapsed time to 3599 seconds, the reasons for which are explained in more detail elsewhere herein.

In a step 1204, the state may be set to an active state, for example, a last state in which the pallet monitoring device was set prior to transitioning to the idle state, which may have been stored and retained in a non-volatile of the pallet monitoring device (e.g., of the IPU 204) prior to a transition to the idle state 1001. In a step 1205, one or more of the components of the pallet monitoring device may be powered on, including any of those described elsewhere herein, for example, one or more sensors and interfaces to same. Which components to turn on may depend, at least in part, on the state set in the step 1204 and functionality and parameter values with which the pallet monitoring device has been configured. The steps 1204 and 1205 collectively may be considered as activating the pallet monitoring device, and may be performed concurrently at least in part or in a reverse order than the order displayed in FIGS. 12A AND 12B.

In a step 1206, one or more other properties (in addition to movement) of the pallet may be detected, for example, by the one or more sensors powered on in the step 1205, and, in a step 1208, these detected properties may be analyzed. The properties detected in the step 1206 and the analysis performed in a step 1208 may be any of those described herein, and may depend on the current state, for example, as described elsewhere herein. For example, the pallet monitoring device may cycle through each pressure sensor included in the pallet monitoring device and detect any signals therefrom with respect to a load borne by the pallet (e.g., weight), and the information embodied in the signals may be analyzed. Further, the pallet monitoring device may cycle through each RFID (UHF/NFC) reader in the pallet monitoring device (in parallel or serially to cycling through the pressure sensors) and detect any signals therefrom regarding the identification of any items loaded on the pallet and/or the ID of the pallet itself, and the ID information embodied in the signals may be analyzed.

In a step 1210, the information detected in step 1206 or otherwise, information determined from the analysis performed in the step 1208, the current time, and other information may be stored on the pallet monitoring device, for example in a non-volatile memory thereof. It should be appreciated that the current time may be determined any time a property is detected, information is determined, or any other action is taken as described herein, and such current time may be recorded and/or transmitted along with information pertaining to the detected property and/or action.

In a step 1212, it may be determined whether there is connectivity to a pallet management network, for example, a gateway or server of the system 900. The determination may be made using a network interface 206 of the IPU 204, for example, a Wi-Fi and/or cell phone interface thereof. In some embodiments, if more than one communication channel can be established to the pallet management network, one may be selected based on any number of factors, for example, cost, speed, throughput capacity and available bandwidth. For example, a communication path through a Wi-Fi connection may be chosen over a cell phone network communication path based on lower cost and/or better throughput capacity. If it is determined in the step 1212 that there is no network connectivity, then the method 1200 may proceed to step 1201 in which the pallet monitoring device returned to the idle state 1001.

If it is determined in the step 1212 that there is network connectivity, then in a step 1214 status information (e.g., any of the information described above in relation to the steps 1206, 1208, 1210) may be transmitted to the pallet management network, for example, a gateway or server of the system 900 described above in relation to FIG. 9A.

In some embodiments, the pallet management network may respond to the transmitted information, for example, with an ACK response or the like. Such a response may specify actions to be taken or provide information from which the pallet monitoring device may determine action is required. Accordingly, the method 1200 may include a step 1216 of determining whether any response to the information transmitted in the step 1214 was received, and, if so, proceed to a step 1218 in which the action may be taken. In a step 1220, it may be determined whether any additional information needs to be transmitted (e.g., as part of the required actions or as a result thereof) to the pallet management network. If so, then the method 1200 may return to the step 1214. If it is determined in the step 1216 that no response was received from the pallet management network or if it is determined in the step 1220 there is no need to transmit any additional information to the pallet management network, then the method 1200 may proceed to a step 1222.

In the step 1222, it may be determined whether to have the pallet monitoring device remain awake, for example, based on the status information and/or information received back from the pallet management network, if any. If it is determined to not remain awake, then the method 1200 may proceed to the step 1201 in which the pallet monitoring device may be returned to the idle state 1001. If it is determined to remain awake, then the method 1200 may proceed to a step 1224, in which sleep mode may be exited, which may result in the current state (set in the step 1204) being processed, for example, as described elsewhere herein. For example, exiting deep sleep mode in the step 1224 may result in a return to the step 1105 of the method 1100.

The steps of the method 1200 may be performed repeatedly (i.e., cyclically) until in the step 1218 it is determined to exit deep sleep mode. The pallet monitoring device 200 may be configured to perform each iteration in about one second, and to remain in an idle state for about 3599 seconds before being woken in the step 1202. Thus, the steps of the method 1200 may repeatedly performed in about one hour (3600 seconds) during which the pallet monitoring device remains active for about one second and idle for about 3599 seconds. That is, the pallet monitoring device may be active less than 0.03% of the cycle; i.e., during deep sleep mode, resulting in low power consumption. Other idle state and active state durations, and ratios between same, may be configured.

FIG. 13 is a flowchart illustrating an example of a method 1300 of transitioning a pallet monitoring device to an idle state (e.g., the idle state 1002), according to embodiments of the system described herein. Other embodiments of transitioning a pallet monitoring device to an idle state, for example, variations of the method 1300, are possible and are intended to fall within the scope of the invention. In a step 1304, components of the pallet monitoring device that are not needed for waking up the pallet monitoring device may be powered down (e.g., switched off). For example, with reference to the pallet monitoring device 200 of FIG. 2, all components except for the timer component 213, movement sensor 216 and the CPU 208 may be powered down, including all the network interface components 206, the sensors 210, 220, the TPM 212 and integrated ambient light sensor 214. In some embodiments, it may be desirable to not switch off all such components. For example, it may be desirable to leave the integrated ambient light sensor 214 powered-on to be able to detect tampering or damage to the pallet monitoring device 200, as described elsewhere herein. During such an idle state, because network interfaces 206 are powered-down, no communications are sent/received from/at the pallet monitoring device, no sensor input is received from the powered-down sensors and no sensor input analyzed such that power can be conserved. The powered-down components may be woken up in response to various conditions, as is described elsewhere herein.

In a step 1306, a wake-up timer may be set. For example, the timer component 213 may be configured to interrupt the CPU 208 after a certain amount of elapsed time and/or at specific times of day, week, month or year. In embodiments of the system described herein in which a pallet management network is employed, the wake-up timer for a pallet monitoring device may be configured to coincide with a schedule of a time slot during which the pallet monitoring device is scheduled to communicate (e.g., report) information to a gateway, for example, as part of a transaction record, as described in more detail elsewhere herein. For example, the wake-up time may be set to about one hour, several hours, once a day, less than one hour or other elapsed times. In some embodiments, it may be desirable to set the amount of elapsed time to 3599 seconds, for example, for reasons described elsewhere herein.

In a step 1308, a movement interrupt may be set, for example, on a movement sensor (e.g., the movement sensor 216) to interrupt the CPU 208 in response to detecting movement. In a step 1310, the defined state of the pallet monitoring device may be changed to the idle state.

By powering off all (or nearly all) pallet monitoring device components not needed to wake-up the pallet monitoring device, power may be conserved. Further, in embodiments in which commercial communications networks (e.g., mobile telephone networks) are employed, the amount of commercial (e.g., cellular) charges may be reduced by reducing the use of communication services as a result of powering down the network communication interfaces on the pallet monitoring device. The amount of power and/or money conserved/saved may be controlled to some extent by configuring the active/idle times within a cycle, which may be balanced against the desire or need to have the most current pallet status information. Further, by powering down and thus reducing the amount of time during which components of the pallet monitoring device is active, the useful life of these components may be extended.

Embodiments of the system described herein concerning monitoring, and managing the lifecycle of, a pallet, can be used in various ways to implement a variety of business processes. These business processes may involve manual actions in combination with automated action, for example automated actions described in relation to FIGS. 9A-13 or elsewhere herein. Further, the automated actions may include automated actions other than those described in relation for FIGS. 9A-13 or elsewhere herein. For example, the loading of a pallet may include a combination of manual and automated actions, and the loading of pallet may be divided into multiple sub-processes, for example, initial loading of a pallet and continued loading of a pallet.

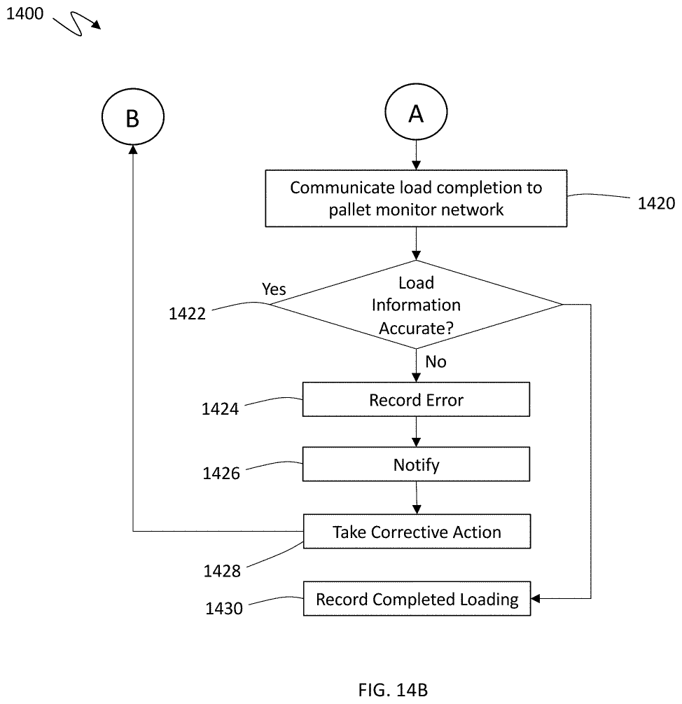

FIGS. 14A and 14B collectively are a flowchart illustrating an example of a method 1400 of managing loading a pallet, according to embodiments of the system described herein. Other embodiments of a method of managing loading a pallet, for example, variations the method 1400, are possible and are intended to fall within the scope of the invention. Such loading may take place at any of a plurality of types of locations, for example, at an industrial plant, e.g., by a plant employee or contractor. A pallet monitoring device may be physically coupled to the pallet, for example, as described in more detail elsewhere herein.

In a step 1402, a bill of lading may be scanned, for example, by a user using a user device (e.g., a user device 942). In response, the user device may inform a pallet management network (e.g., the network 900) about the bill of lading information in a step 1404. For example, the user device may transmit the scanned bill of lading information to a gateway of the pallet management network, which then may transmit this information to a services layer and/or a transformation layer of the pallet management network. One or more of these communications between components of the network (and other communications between network components as part of performing the method 1400) may be performed using techniques described elsewhere herein, for example, using blockchain technique and/or per a predefined schedule, and may be stored on any one of the network components, for example, as a transaction block of a blockchain. In the step 1404, the information transmitted to the pallet management network may be part of a communication that indicates to the network that a process of loading the pallet has started.

In a step 1406, a QRC label may be read from an item to be loaded on to the pallet in accordance with the bill of lading. For example, the user device may have a reader that can read the QRC label on the loading item, which may include a serial number of the product (or the serial number may be separately scanned). Alternatively, the QRC label may be read as a result of the item being loaded onto a pallet monitoring device as described in more detail elsewhere herein. In a step 1408, the pallet management network may be informed of information associated with the read QRC label (e.g., a type, brand, serial number, size, vendor, contents, location (e.g., plant), etc. of the item), for example, using similar techniques as described in relation to step 1404.

In a step 1410, the item may be loaded onto the pallet, and, in a step 1412, the loading of the item onto the pallet may be detected, for example, by one or more sensors of a pallet monitoring device, as described in more detail elsewhere herein. For example, the placing of the item on the pallet my wake-up the pallet monitoring device from an idle state. Pallet-associated information may be communicated to the pallet management network in a step 1414, for example, by the pallet monitoring device, e.g., as described in more detail elsewhere herein. The pallet-associated information may include raw information detected by one more sensors or information determined by the pallet monitoring device based at least in part on the raw information detected. Such information may include serial number, weight, pallet ID, pallet monitoring device ID, etc. One or more applications in the transformation layer 902 may be configured to combine and correlate any information communicated to the pallet management network in relation to the steps 1404, 1408, 1414, and may include logic for analyzing the information and making determinations and decisions in relation to same. One or more gateways, user devices, pallet monitoring devices (e.g., IPUs), or other network components may be configured (collectively and/or individually) with logic to perform the foregoing as well.

In a step 1416, the pallet load information communicated to the pallet management network may be confirmed; i.e., it may be determined whether the communicated pallet load information is accurate, e.g., by comparing information set forth in, or determined from, the bill of lading to information determined from the QRC label and/or information detected or determined by the pallet monitoring device. If the information is determined not to be accurate, then the error may be recorded in a step 1411 (e.g., in one or more components of the pallet management network), and in a step 1413 one or more parties (e.g., the user, owner, OEM, producer, transporter, licensor, etc., owner of the pallet and/or items being carried thereon) may be notified of the error. In a step 1415, one or more corrective actions may be taken. For example, information associated with the QRC label and/or bill of lading may be examined to determine any discrepancies and this information may be corrected, or one or more components of the pallet monitoring device may be tested and repaired or adjusted as necessary. After one or more corrective actions, if any, are taken, the method may return to the step 1406 (or even 1402 if the bill of lading was adjusted). For example, the read RFIDs , determined weights, determined location and geometry of the loaded items and/or the pallet itself, and other information may be compared to what is specified in the bill of lading.

If it is determined in the step 1416 that the load information is accurate, then in a step 1418 it may be determined whether there is a next item to be loaded. For example, a user may indicate via a user device (e.g., proactively or in response to an inquiry) whether there is any next item, or alternatively whether loading of the pallet is complete. If it determined that there is a next item to be loaded in the step 1418, then the method 1400 may return to the step 1406 to be performed for the next item. If it is determined in the step 1418 that there is not a next item to be loaded; i.e., that loading is complete, then in a step 1420, the completion of the load may be communicated to the pallet management network, for example, by the user device and/or pallet monitoring device.

In a step 1422, the correct loading of the pallet may be verified; i.e., it may be determined whether load information is correct. The step 1420 may be similar to the step 1416, except that the step 1420 may be performed for the completed load, whereas the step 1416 may be performed for only a portion of the load, for example, less than all of the items of the load (e.g., the first item of the load). Similar to the step 1416, the step 1420 may include comparing bill of lading information to information detected by the pallet monitoring device or determined by the pallet monitoring device and/or other components of the pallet management network. If it is determined in the step 1422 that the load is inaccurate, then steps 1424, 1426 and 1428 may be performed in a same or similar manner as the steps 1411, 1413 and 1415 describe above, except for the completed loading information.

Various embodiments of the system described herein may be combined to realize substantial communication cost savings for a customer. For example, consider a fleet of 10,000 Euro pallets owned by an OEM being monitored and managed using the pallet management network 900, employing pallet monitoring devices as described herein, and employing the lifecycle management techniques described herein, of which: 1,000 Euro pallets are in a deep sleep mode at an OEM site awaiting to be prepared for use; 400 are in a deep sleep mode being transported from an OEM site to a customer site; 600 are in a deep sleep mode being transported from a customer site back to an OEM site; and 8,000 are at customer sites, 3,000 of which are connected to the pallet management network via a cellular telephony network, and 5,000 via only a Wi-Fi network path. In this example, the 2,000 pallets in deep sleep mode would generate negligible communication charges, and the 5,000 pallets communicating with the pallet management network via only Wi-Fi may generate no additional communication charges. Only the 3,000 pallets communicating with the pallet management network using a cellular telephony network may generate communication charges, which would represent about 70% communication savings compared to the system without a deep sleep mode of operation in which all communications utilize a cellular telephony network.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, firmware, hardware, a combination of software, firmware and/or hardware and/or other computer-implemented modules or devices having the described features and performing the described functions.

Software implementations of the system described herein may include executable code that is stored on one or more computer readable media and executed by one or more processors. Each of the one or more computer readable media may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. In some embodiments of the system described herein, one or more computer media may be, include, or be included within a TPM of a server, gateway, pallet monitoring device or other component of a pallet management network, as described in more detail elsewhere herein, providing a secure environment for storing, executing and updating software implementations of the system described herein. The system described herein may be used in connection with any appropriate operating system.

Other embodiments of the system described herein will be apparent to those skilled in the art from a consideration of the specification or practice of the system disclosed herein. It is intended that the specification and examples be considered as exemplary only, with the true scope and spirit of the invention being indicated by the following claims.

What is claimed is:

1. A device for monitoring a pallet, comprising:
one or more layers including one or more elements for attaching the device to the pallet;
one or more sensors physically coupled to the one or more layers, the one or more sensors detecting one or more properties associated with the pallet, each of the one or more sensors producing a signal indicative of one or more properties associated with the pallet; and
a processing unit physically coupled to the one or more layers and communicatively coupled to the one or more sensors, the processing unit receiving and processing signals produced by the one or more sensors.

2. The device according to claim 1, wherein the one or more properties include one or more properties of the pallet.

3. The device according to claim 1, where the one or more properties include one or more properties of a load carried by the pallet.

4. The device according to claim 1, wherein the one or more sensors include at least a first sensor for detecting a weight of a load carried by the pallet.

5. The device according to claim 1, wherein a load carried by pallet includes a one or more items, and wherein the one or more sensors include at least a first sensor for detecting a location of at least a first of the one or more items relative to the pallet.

6. The device according to claim 1, wherein the one or more sensors include at least a first sensor for detecting an identifier of the pallet and/or an identifier of one or more items carried by the palette.

7. The device according to claim 1, wherein the one or more sensors include one or more hydraulic mats.

8. The device according to claim 1, wherein the one or more sensors include at least one of: one or more RFID (UHF) readers or one or more RFID (NFC) readers.

9. The device according to claim 1, wherein the one or more sensors include at least one sensor positioned at a location within the assembly based at least in part on one or more types of anticipated loads of the pallet.

10. The device according to claim 9 wherein the at least one sensor includes a plurality of sensors arranged in a pattern based at least in part on the one or more types of anticipated loads of the pallet.

11. The device according to claim 1, wherein at least one of the sensors is arranged at a location within the assembly based at least in part on an anticipated location of a block within the pallet.

12. The device according to claim 11, wherein a plurality of the sensors are arranged in a pattern based at least in part on standardized requirements of a Euro pallet.

13. The device according to claim 1, wherein the device has one or more physical dimensions based at least in part on standardized requirements of a Euro pallet.

14. The device according to claim 1, wherein the device has one or more layers including a cavity for accommodating at least one of the one or more sensors.

15. The device according to claim 1, wherein the device has one or more layers including a cavity for accommodating one or more electrical components.

16. The device according to claim 1, wherein the device has one or more layers for accommodating straps that secure items carried by the pallet to the assembly.

17. The device according to claim 1, wherein the device has one or more layers for accommodating straps that secure the assembly to the pallet.

18. The device according to claim 1, wherein the device includes a plurality of layers, at least a first layer of the plurality of layers having a first surface for contacting the pallet and a second surface for contacting at least a second layer of the plurality of layers, the at least second layer accommodating the one or more sensors.

19. The device according to claim 1, wherein the processing unit includes one or more network interfaces to communicate status information associated with the pallet to a pallet management network.

20. The device according to claim 19, wherein the one or more network interfaces communicate status information associated with the pallet as transaction blocks of a blockchain.

21. The device according to claim 19, wherein the one or more network interfaces receive a remotely transmitted digitally signed software update, the device logic authenticates the software update and, if the software is authentic, update software on the at least one device with the authenticated software.

22. The device according to claim 1, wherein the processing unit includes a trusted platform module to secure information stored on and/or communicated from the device.

23. The device according to claim 1, wherein the processing unit determines one or more actions to be taken for the pallet based at least in part on the one or more detected properties.

24. A method of monitoring a pallet using a device physically coupled thereto, comprising:
detecting one or more properties associated with the pallet using one or more sensors included in the device to produce a signal indicative of the one or more properties; and
processing the signals produced by the one or more sensors using a processor included in the device.

25. The method of claim 24, wherein detecting one or more properties includes detecting a fluid pressure acting on the device.

26. The method of claim 25, further comprising:
determining a weight of a load carried by the pallet from the detected fluid pressure.

27. The method of claim 24, wherein detecting one more properties includes detecting the presence of one or more items carried by the pallet.

28. The method of claim 24, further comprising:
transmitting one or more communication to a network, the one or more communications including information based on the one or more detected properties.

29. The method of claim 24, wherein the one or more sensors include one or more hydraulic mats.

30. The method of claim 24, wherein the one or more sensors include at least one of: one or more RFID (UHF) readers or one or more RFID (NFC) readers.

31. The method of claim 24, wherein the one or more sensors include at least one sensor positioned at a location within the assembly based at least in part on one or more types of anticipated loads of the pallet.

32. The method of claim 31, wherein the at least one sensor includes a plurality of sensors arranged in a pattern based at least in part on the one or more types of anticipated loads of the pallet.

33. The method of claim 24, wherein at least one of the sensors is arranged at a location within the assembly based at least in part on an anticipated location of a block within the pallet.

34. The method of claim 33, wherein a plurality of the sensors are arranged in a pattern based at least in part on standardized requirements of a Euro pallet.

35. The method of claim 24, wherein the processor is coupled to one or more network interfaces to communicate status information associated with the pallet to a pallet management network.

36. The method of claim 35, wherein the one or more network interfaces communicate status information associated with the pallet as transaction blocks of a blockchain.

37. The method of claim 35, wherein the one or more network interfaces receive a remotely transmitted digitally signed software update, the device logic authenticates the software update and, if the software is authentic, update software on the at least one device with the authenticated software.

38. The method of claim 24, wherein the processor is coupled to a trusted platform module to secure information stored on and/or communicated from the device.

39. The method of claim 24, wherein the processor determines one or more actions to be taken for the pallet based at least in part on the one or more detected properties.

40. A method of making a device for monitoring a pallet, comprising:
providing a first layer of the device having a first surface to contact loads carried by a pallet;
placing one or more sensors for detecting one or more properties associated with the pallet on the first layer to produce a signal indicative of one or more properties associated with the pallet;
placing a processing unit in the first layer, the processing unit to receive and process signals produced by the one or more sensors; and
placing at least a second layer over the first layer, the at least second layer having a second surface for contacting a pallet.

41. The method according to claim 40, wherein the first layer has one or more cavities, wherein placing the one or more sensors includes placing at least one of the one or more sensors in one of the one or more cavities, and wherein placing the processing unit includes placing the processing unit within one of the one or more cavities.

42. The method according to claim 40, wherein placing one or more sensors includes placing one or more hydraulic mats on the first layer.

43. The method according to claim 40, wherein placing one or more sensors includes placing one or more of: RFID (UHF) readers or RFID (NFC) readers.

44. The method according to claim 40, further comprising;
downloading IPU software to the IPU, wherein the IPU software includes device under test functionality;
personalizing the IPU with public and private keys;
locking the TPM after personalizing the IPU;
determining whether the one or more sensors and the processing unit are working satisfactorily;
if the one or more sensors or the processing unit are not working satisfactorily, performing corrective action; and
repeating the determining and the performing of corrective action if necessary until it is determined that the one or more sensors and processing unit are working properly, wherein the at least second layer is placed over the first layer only after it is determined that the one or more sensors and processing unit are working properly.
